(19) United States
(12) Patent Application Publication
(10) Pub. No.: US 2017/0262220 A1
(43) Pub. Date: Sep. 14, 2017

(54) STORAGE CONTROL DEVICE, METHOD OF CONTROLLING DATA MIGRATION AND NON-TRANSITORY COMPUTER-READABLE STORAGE MEDIUM

(71) Applicant: FUJITSU LIMITED, Kawasaki-shi (JP)

(72) Inventor: Atsushi TAKAKURA, Kawasaki (JP)

(73) Assignee: FUJITSU LIMITED, Kawasaki-shi (JP)

(21) Appl. No.: 15/408,985

(22) Filed: Jan. 18, 2017

(30) Foreign Application Priority Data
Mar. 11, 2016 (JP) 2016-048234

(51) Int. Cl. G06F 3/06

(52) U.S. Cl. CPC G06F 3/0647; G06F 3/0604; G06F 3/0653; G06F 3/0683

(57) ABSTRACT

A storage control device configured to control data migration from a first storage area of a first capacity to a second storage area, the storage control device includes a processor configured to migrate, from the first storage area to the second storage area, a plurality of data of a certain size in order based on addresses of the plurality of data in the first storage area, update first information indicating the address of the data in the first storage area, the data being migrated to the second storage area, when the respective data is migrated to the second storage area in order, specify a second capacity, which is a total capacity of the data migrated to the second storage area, based on the updated first information, determine whether the specified second capacity reaches the first capacity, and stop migrating the data when the second capacity reaches the first capacity.

### CROSS-REFERENCE TO RELATED APPLICATION

This application is based upon and claims the benefit of priority of the prior Japanese Patent Application No. 2016-048234, filed on Mar. 11, 2016, the entire contents of which are incorporated herein by reference.

### FIELD

The embodiments discussed herein are related to a storage control device, a method of controlling data migration and a non-transitory computer-readable storage medium.

### BACKGROUND

In a case, for example, where a storage device in use has deteriorated with age, a replacement operation is usually performed to replace the storage device in use with a new storage device. For the replacement operation, there is a technique of migrating data from a storage device in use to a new storage device without stopping operation.

Regarding a related-art technique, for example, there is a technique of allocating a storage area from a first pool in response to a write request and controlling allocation of storage areas for multiple sets of related data, which are to be allocated from the first pool, from various specific redundant arrays of inexpensive disks (RAID) groups in the first pool. In addition, for example, there is a technique of migrating a virtual logical volume to a real logical volume. Moreover, for example, there is a technique of consecutively restoring all sets of data by reallocating a physical disk device, in response to a reallocation instruction issued by a maintenance engineer, between two specified logical disk devices. The related-art techniques are disclosed in Japanese Laid-open Patent Publication Nos. 2013-109749, 2011-13800, and 9-274544.

### SUMMARY

According to an aspect of the invention, a storage control device configured to control data migration from a first storage area of a first capacity to a second storage area, the storage control device includes a memory and a processor coupled to the memory and configured to migrate, from the first storage area to the second storage area, a plurality of data of a certain size in order based on addresses of the plurality of data in the first storage area, update first information indicating the address of data in the first storage area, the data being included in the plurality of data and being migrated to the second storage area, when the respective data is migrated to the second storage area in order, store, in the memory, the updated first information, specify a second capacity, which is a total capacity of the data migrated to the second storage area, based on the updated first information stored in the memory, determine whether the specified second capacity reaches the first capacity, and stop migrating the data when it is determined that the second capacity reaches the first capacity.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a storage control method according to an embodiment;

FIG. 2 is an explanatory diagram illustrating an example of a storage system 200;

FIG. 3 is an explanatory diagram illustrating a hardware configuration example of storage devices 201 and 202;

FIG. 4 is a block diagram illustrating a hardware configuration example of a host device 203;

FIG. 5 is an explanatory diagram illustrating an example of contents stored in a migration management table 500;

FIG. 6 is a block diagram illustrating a functional configuration example of a storage control device 100;

FIG. 7 is an explanatory diagram (part 1) illustrating an example of data migration according to an operation example 1;

FIG. 8 is an explanatory diagram (part 2) illustrating the example of the data migration according to the operation example 1;

FIG. 9 is an explanatory diagram (part 1) illustrating read processing during the data migration according to the operation example 1;

FIG. 10 is an explanatory diagram (part 2) illustrating the read processing during the data migration according to the operation example 1;

FIG. 11 is an explanatory diagram (part 1) illustrating write processing during the data migration according to the operation example 1;

FIG. 12 is an explanatory diagram (part 2) illustrating the write processing during the data migration according to the operation example 1;

FIG. 13 is an explanatory diagram illustrating an example of determination to terminate the migration according to the operation example 1;

FIG. 14 is an explanatory diagram (part 1) illustrating an example of data migration according to an operation example 2;

FIG. 15 is an explanatory diagram (part 2) illustrating the example of the data migration according to the operation example 2;

FIG. 16 is an explanatory diagram (part 3) illustrating the example of the data migration according to the operation example 2;

FIG. 17 is an explanatory diagram illustrating read processing during the data migration according to the operation example 2;

FIG. 18 is an explanatory diagram illustrating write processing during the data migration according to the operation example 2;

FIG. 19 is an explanatory diagram illustrating an example of determination to terminate the migration according to the operation example 2;

FIG. 20 is a flowchart illustrating an example of a migration processing procedure;

FIG. 21 is a flowchart illustrating an example of a normal processing procedure;

FIG. 22 is a flowchart (part 1) illustrating an example of a processing procedure for thin provisioning;

FIG. 23 is a flowchart (part 2) illustrating the example of the processing procedure for thin provisioning;

FIG. 24 is a flowchart illustrating an example of a read processing procedure; and

FIG. 25 is a flowchart illustrating an example of a write processing procedure.

### DESCRIPTION OF EMBODIMENTS

With the above-described related-art techniques, a size of management data sometimes increases, which is used for managing a progress of migrating data from a migration source storage device to a migration destination storage device. For example, in a case of using a bitmap as the management data, which indicates whether or not each set of data having a unit capacity of the migration source storage device has been migrated, the size of the management data increases as a capacity of the migration source storage device increases.

An embodiment of a storage control device, a storage control method, and a storage control program according to the disclosure are described below in detail with reference to the drawings.

### Example of Storage Control Method According to Embodiment

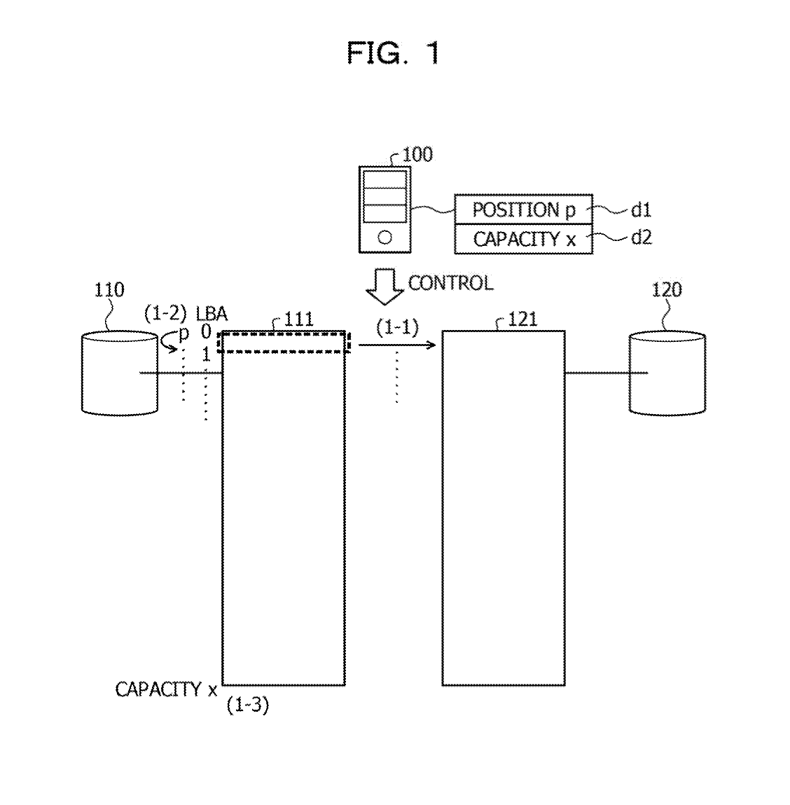

FIG. 1 is an explanatory diagram illustrating an example of a storage control method according to the embodiment. In FIG. 1, a storage control device 100 is a computer that migrates data from a migration source logical volume 111 to a migration destination logical volume 121.

Here, migration of the data from the migration source logical volume 111 to the migration destination logical volume 121 may occur without stopping operation. For example, a bitmap, which manages a migration state of each set of data having a unit capacity of the migration source logical volume 111, may be used in this case. The bitmap is data that allocates information with 1 bit, which indicates whether or not each set of the data having the unit capacity of the migration source logical volume 111 has been migrated, to each set of such data. Thereby, the bitmap presents whether or not such data has been migrated. The unit capacity is 512 kilobytes (KB), for example.

To be specific, by using the bitmap, data having the unit capacity that has not been migrated is specified, and thus, the migration state is managed. Thus, the data in the migration source logical volume 111 is migrated to the migration destination logical volume 121. In addition, even when a read request or a write request is received from a host device and thus the migration is interrupted by executing read processing and write processing in either the migration source logical volume 111 or the migration destination logical volume 121, using the bitmap makes it possible to maintain the migration state.

As described above, by using the bitmap, a response to the read request or the write request from the host device is performed so as to avoid stopping operation. In this case, the read processing and write processing are executed for each set of the data having the unit capacity in order to keep the migration state maintained by the bitmap with maintaining consistency between the migration source logical volume 111 and the migration destination logical volume 121.

However, in this case, a size of the bitmap is likely to increase as a capacity of the migration source logical volume 111 increases. Thus, this unfortunately forces a memory including a storage area with a size capable of storing the bitmap to be prepared due to the increase in capacity of the migration source logical volume 111.

To address this, it is conceivable that the increase in the size of the bitmap is suppressed by setting the unit capacity to a comparatively large value. However, in this case, since the read processing and the write processing are executed for each set of the data having the unit capacity when receiving the read request and the write request from the host device, the processing amounts of the read processing and the write processing increases. In addition, this may cause increase in time to respond to the host device and a fail of responding to the host device within a specified time. Hence, deterioration in response performance may be caused.

The embodiment describes a storage control method that is capable of suppressing increase in time to respond to a host device while suppressing increase in size of the management data used for managing a progress of data migration.

In the example in FIG. 1, the migration source logical volume 111 is implemented by a migration source storage device 110. The migration source storage device 110 is one or more disks, for example. The migration destination logical volume 121 is implemented by a migration destination storage device 120. The migration destination storage device 120 is one or more disks, for example.

The storage control device 100 is a migration destination computer including the migration destination storage device 120, for example. Otherwise, the storage control device 100 may be a migration source computer including the migration source storage device 110, for example. In addition, the storage control device 100 may be a computer different from the migration destination computer including the migration destination storage device 120 and the migration source computer including the migration source storage device 110.

The storage control device 100 stores migration management information, which includes first information d1 and second information d2, as the management data used for managing the progress of the data migration. The first information d1 indicates a position, in the migration source logical volume 111, of the latest data migrated from the migration source logical volume 111. The first information d1 is a logical block addressing (LBA) value in the migration source logical volume 111, for example. To be specific, the first information d1 may be presented as LBA of a sector, which indicates the beginning of such a sector in which data following the latest migrated data is stored, as the position of the latest migrated data. The sector is an area with 512 KB, for example. The second information d2 is information indicating the capacity of the migration source logical volume 111.

(1-1) The storage control device 100 sequentially reads the data from the beginning or the ending of the migration source logical volume 111, and migrates the data to the migration destination logical volume 121. For example, the storage control device 100 sequentially reads units of 512 KB of the data from the beginning of the migration source logical volume 111, and migrates the data to the migration destination logical volume 121.

(1-2) The storage control device 100 updates the first information d1 at every moment the data is migrated to the migration destination logical volume 121. For example, in a case where 512 KB of data is read from the migration source logical volume 111 and migrated to the migration destination logical volume 121, the storage control device 100 updates the first information d1 by adding a value of 512 KB “1” to the LBA value indicated by the first information d1.

(1-3) At every moment the data is migrated, the storage control device 100 determines whether or not a capacity migrated from the migration source logical volume 111 is equal to or greater than the capacity of the migration source logical volume 111 based on the first information d1 and the second information d2. Then, when the migrated capacity is determined to be equal to or greater than the capacity of the migration source logical volume 111, the storage control device 100 terminates the reading of the data from the migration source logical volume 111.

To be specific, the storage control device 100 calculates the migrated capacity by multiplying the LBA value, which is indicated by the first information d1, by 512 KB, which is the size of the sector, and determines whether or not the migrated capacity is equal to or greater than the capacity of the migration source logical volume 111. Then, when the migrated capacity is equal to or greater than the capacity of the migration source logical volume 111, the storage control device 100 terminates the reading of the data from the migration source logical volume 111.

Note that in a case of sequentially reading and migrating each set of the data of multiple sectors, the storage control device 100 may try to read the data from the sector indicated by an LBA value greater than the latest LBA in the migration source logical volume 111. In this case, the LBA value indicated by the first information d1 becomes greater than the latest LBA value, and the value calculated as the migrated capacity becomes greater than the capacity actually migrated.

Even in such a case, since the reading of the data from the sector indicated by the LBA value greater than the latest LBA in the migration source logical volume 111 fails, the storage control device 100 does not have to migrate the data of such a sector, which is improper data. In addition, since the migrated capacity is equal to or greater than the capacity of the migration source logical volume 111, the storage control device 100 is capable of determining that the sector failing to be read is a sector that does not have to be read, and determining that the migration terminates normally.

In this way, the storage control device 100 is capable of managing the progress of the data migration from the migration source logical volume 111 to the migration destination logical volume 121 without using the bitmap as the management data for managing the progress of the data migration.

This makes the storage control device 100 to be capable of suppressing the increase in the size of the management data, which manages the progress of the data migration, even when the capacity of the migration source logical volume 111 increases. In addition, since the bitmap is not used, when receiving the read request and the write request from the host device, the storage control device 100 may be capable of executing the read processing and the write processing for each set of the data having comparatively small capacity, thereby suppressing the increase in the time to respond to the host device.

Moreover, in response to the read request and the write request, the storage control device 100 is capable of specifying how to execute the read processing and the write processing in the migration source logical volume 111 and the migration destination logical volume 121 to succeed in the read processing and the write processing. Further, even when the data migration is interrupted by the read processing and the write processing, the storage control device 100 is capable of managing the progress of the data migration. This makes it possible to restart the data migration.

The case where the first information d1 is the LBA value in the migration source logical volume 111 is described herein; however, the case is not limited to this. For example, the first information d1 may be information indicating the migrated capacity of the migration source logical volume 111. Based on the beginning position of the migration source logical volume 111 and the migrated capacity of the migration source logical volume 111, the storage control device 100 is capable of specifying the position of the latest data migrated from the migration source logical volume 111.

The case where the second information d2 is the capacity of the migration source logical volume 111 is described herein; however, the case is not limited to this. For example, the second information d2 may be an LBA value of the sector at the ending of the migration source logical volume 111. Based on the LBA value of the sector at the ending of the migration source logical volume 111, the storage control device 100 is capable of specifying the capacity of the migration source logical volume 111.

In addition, in a case where the LBA value indicating the position of the latest migrated data is equal to or greater than the LBA value of the sector at the ending of the migration source logical volume 111, the storage control device 100 may determine that the migrated capacity is equal to or greater than the capacity of the migration source logical volume 111.

### Example of Storage System 200

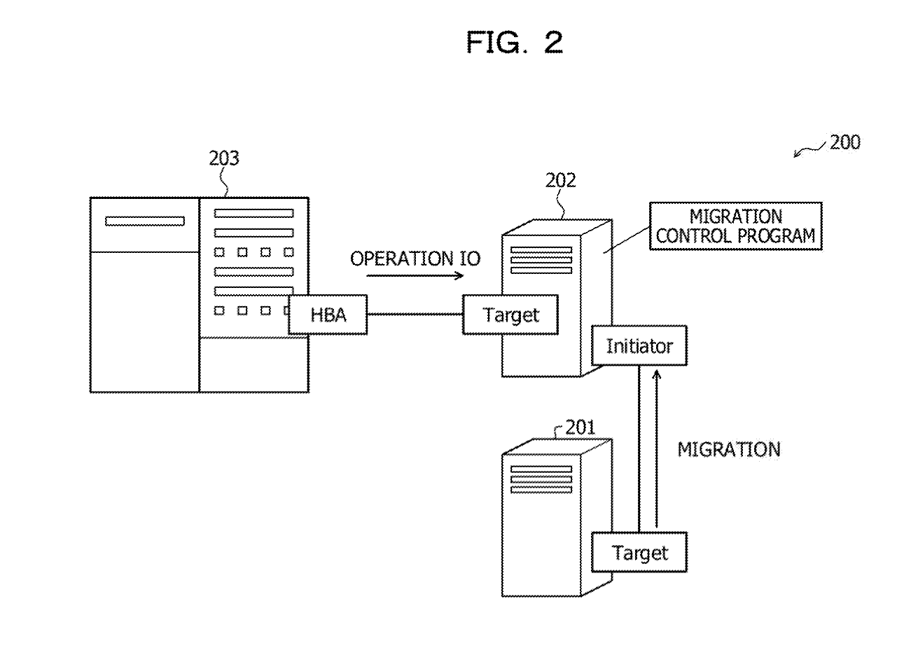

Next, an example of a storage system 200 applied with the storage control device 100 illustrated in FIG. 1 is described with reference to FIG. 2.

FIG. 2 is an explanatory diagram illustrating the example of the storage system 200. In FIG. 2, the storage system 200 includes a migration source storage device 201, a migration destination storage device 202, and a host device 203. In the storage system 200, the migration source storage device 201 and the migration destination storage device 202 are coupled via a wired or wireless dedicated line, for example.

The migration source storage device 201 and the migration destination storage device 202 may be coupled via multiple paths, for example. When the communication using either path fails, the migration source storage device 201 and the migration destination storage device 202 may try to communicate using another path. In addition, in the storage system 200, the migration source storage device 201 and the migration destination storage device 202 may be coupled via a wired or wireless network and the like, for example.

The migration source storage device 201 is a computer, which includes one or more storage devices and stores data in a logical volume implemented by its own one or more storage devices. The storage device is a disk, for example. The migration source storage device 201 controls the data input-output of the migration destination storage device 202 by Target, for example.

The migration destination storage device 202 is a computer, which stores the storage control program according to the embodiment and executes the storage control program according to the embodiment. The migration destination storage device 202 includes one or more storage devices and migrates the data in the migration source storage device 201 to a logical volume implemented by its own one or more storage devices. The migration destination storage device 202 controls the data input-output of the migration source storage device 201 and the host device 203 by Target and Initiator, for example.

The host device 203 is a computer, which transmits the read request and the write request to the migration destination storage device 202, for example. The host device 203 controls the data input-output of the migration destination storage device 202 based on a host bus adapter (HBA), for example. To be specific, the host device 203 is a server, a personal computer (PC), a laptop, a mobile phone, a smartphone, a tablet, personal digital assistants (PDA), or the like.

A case where the migration destination storage device 202 executes the storage control program according to the embodiment and operates as the storage control device 100 in FIG. 1 is described below; however, the case is not limited to this. For example, the migration source storage device 201 may execute the storage control program according to the embodiment and operate as the storage control device 100 in FIG. 1. Otherwise, the host device 203 may execute the storage control program according to the embodiment and operate as the storage control device 100 in FIG. 1.

### Hardware Configuration Example of Storage Devices 201 and 202

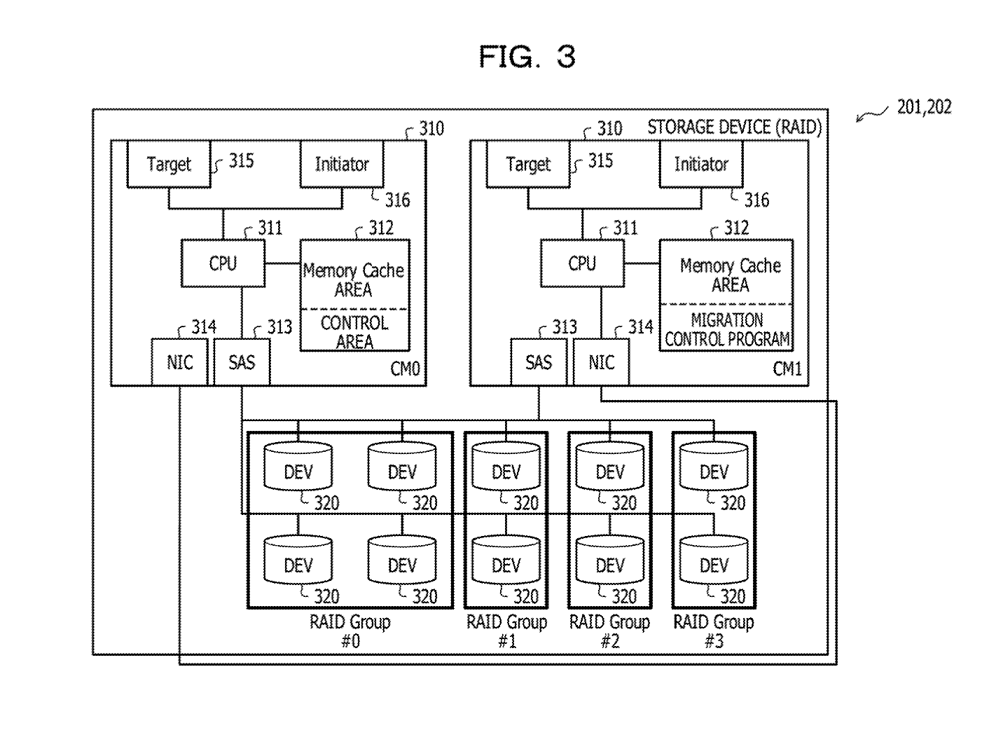

Next, a hardware configuration example of each of the storage devices 201 and 202 for the migration source and the migration destination is described with reference to FIG. 3.

FIG. 3 is an explanatory diagram illustrating the hardware configuration example of the storage devices 201 and 202. In FIG. 3, the storage devices 201 and 202 include control modules (CMs) 310 and devices 320. Each CM 310 includes a central processing unit (CPU) 311, a memory 312, a serial attached SCSI (SAS) 313, a network interface card (NIC) 314, Target 315, and Initiator 316.

The CPU 311 is configured to control the entire CM 310. For example, the CPU 311 executes various programs including a program such as the storage control program according to the embodiment, which are stored in the memory 312. The memory 312 includes a read only memory (ROM), a random access memory (RAM), a flash ROM, and the like, for example. To be specific, a flash ROM and a ROM store various programs including a program such as the storage control program according to the embodiment, and a RAM is used as a work area for the CPU 311, for example. The programs stored in the memory 312 are loaded into the CPU 311, thereby making the CPU 311 to execute the coded processing.

Each device 320 is a disk, for example. The device 320 is installed in a disk enclosure (DE), for example. One or more devices 320 may be used to implement RAID Group. The SAS 313 controls an interface to the device 320. The device 320 is used to implement a logical volume. The NIC 314 controls an interface between the CMs. Target 315 controls an interface in a case of receiving the read request and the write request from an external device such as the host device 203, as a client. Initiator 316 controls an interface in a case of outputting the read request and the write request to an external device such as the host device 203.

### Hardware Configuration Example of Host Device 203

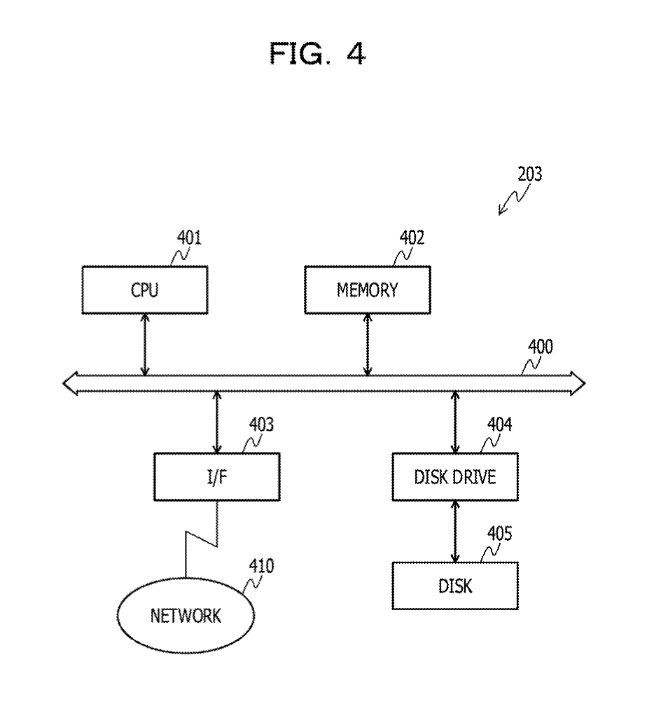

Next, a hardware configuration example of the host device 203 is described with reference to FIG. 4.

FIG. 4 is a block diagram illustrating the hardware configuration example of the host device 203. In FIG. 4, the host device 203 includes a CPU 401, a memory 402, an interface (I/F) 403, a disk drive 404, and a disk 405. In addition, these constituents are coupled to each other via a bus 400.

In this case, the CPU 401 is configured to control the entire host device 203. The memory 402 includes a ROM, a RAM, a flash ROM, and the like, for example. To be specific, a flash ROM and a ROM store various programs, and a RAM is used as a work area for the CPU 401, for example. The programs stored in the memory 402 are loaded by the CPU 401, and the CPU 401 is then made to execute the coded processing.

The I/F 403 is coupled to a network 410 via a communication line, and coupled to another computer (the migration destination storage device 202 illustrated in FIG. 2, for example) via the network 410. In addition, the I/F 403 is an interface for the network 410 and the inside, and configured to control input and output of the data with respect to the other computer. An HBA may be applied as the I/F 403, for example.

The disk drive 404 is controlled by the CPU 401, thereby controlling read/write of the data from/to the disk 405. The disk drive 404 is a magnetic disk drive, for example. The disk 405 is a non-volatile memory that stores the data controlled by the disk drive 404 to be written. The disk 405 is a magnetic disk, an optical disk, or the like, for example.

The host device 203 may include a solid state drive (SSD), a semiconductor memory, a keyboard, a mouse, a display, and the like in addition to the above-described constituents, for example. Moreover, the host device 203 may include an SSD and a semiconductor memory instead of the disk drive 404 and the disk 405.

### Example of Contents Stored in Migration Management Table 500

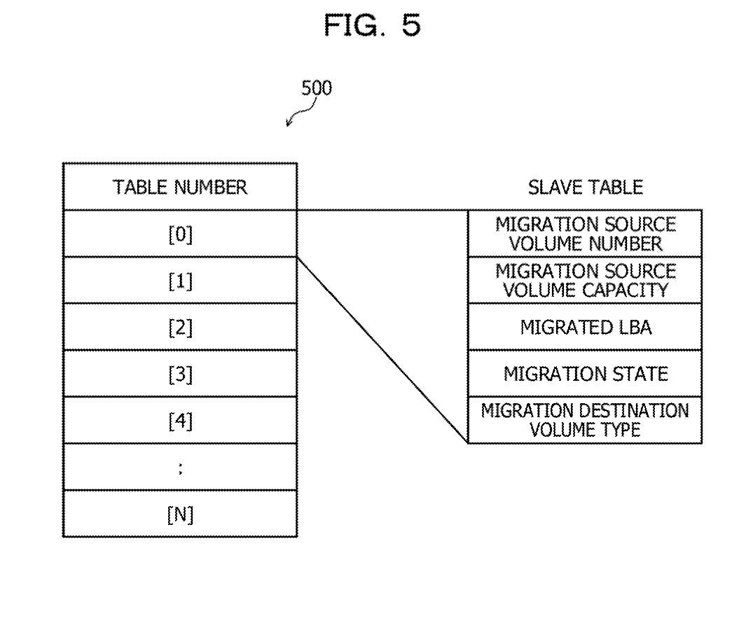

Next, an example of contents stored in a migration management table 500 is described with reference to FIG. 5. The migration management table 500 is implemented by a storage area in the memory 312 and the like illustrated in FIG. 3, for example.

FIG. 5 is an explanatory diagram illustrating the example of the contents stored in the migration management table 500. As illustrated in FIG. 5, the migration management table 500 includes fields for a table number, a migration source volume number, a migration source volume capacity, migrated LBA, a migration state, and a migration destination volume type. The migration management table 500 sets information for respective fields in each migration source logical volume 111, thereby storing migration management information, which is to be the management data, as a record.

The table number is a number allocated to each slave table included in the migration management table 500. The slave table, which includes the fields such as the migration source volume number, the migration source volume capacity, the migrated LBA, the migration state, and the migration destination volume type, is stored in association with the table number.

The migration source volume number is a number that identifies the migration source logical volume 111. The migration source volume capacity is the capacity of the migration source logical volume 111. The migrated LBA is an LBA value in the migration source logical volume 111 and is information indicating the ending of the data migrated from the migration source logical volume 111. The migration state is information indicating whether the current state is during migration, migration completed, or an error. The migration destination volume type is information indicating whether or not the migration destination logical volume 121 is a logical volume for thin provisioning.

### Functional Configuration Example of Storage Control Device 100

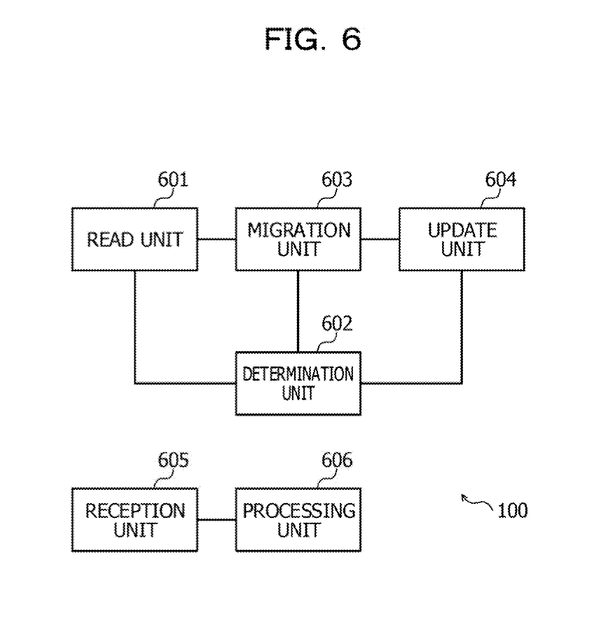

Next, a functional configuration example of the storage control device 100 is described with reference to FIG. 6.

FIG. 6 is a block diagram illustrating the functional configuration example of the storage control device 100. The storage control device 100 includes a read unit 601, a determination unit 602, a migration unit 603, an update unit 604, a reception unit 605, and a processing unit 606.

The read unit 601 to the processing unit 606 are functions to be performed as a control unit. For example, the read unit 601 to the processing unit 606 implement these functions by making the CPU 311 to execute the programs stored in the memory 312 illustrated in FIG. 3, or by using the SAS 313, the NIC 314, Target 315, and Initiator 316. Processing results of these functions are stored in a storage area in the memory 312 and the like, for example.

The read unit 601 sequentially reads a unit length of data from the beginning or the ending of the migration source logical volume 111. For example, the read unit 601 issues the read request to the migration source storage device 201, thereby sequentially receiving each set of a predetermined amount of the data from the beginning of the migration source logical volume 111 included in the migration source storage device 201.

To be specific, the read unit 601 issues the read request to the migration source storage device 201 based on the first information d1 included in the migration management information stored in a storage unit. The storage unit is the migration management table 500, for example. The first information d1 is the information indicating a position of the data in the migration source logical volume 111. The first information d1 is the LBA value of the field for the migrated LBA in the migration management table 500, for example. To be more specific, the read unit 601 issues the request for reading the data of one or more sectors counted from the beginning of the sector indicated by the LBA value of the field for the migrated LBA in the migration management table 500, to the migration source storage device 201. In this way, the read unit 601 is capable of obtaining the data to be migrated to the migration destination logical volume 121 and outputting such data to the migration unit 603.

When the migration destination logical volume 121 is the logical volume for thin provisioning, the determination unit 602 determines whether or not the storage area in the migration source logical volume 111 associated with a management unit of thin provisioning is a free space. For example, the determination unit 602 determines whether or not the migration destination volume type in the migration management table 500 indicates the logical volume for thin provisioning. When the migration destination volume type in the migration management table 500 indicates the logical volume for thin provisioning, the determination unit 602 determines whether or not the storage area in the migration source logical volume 111 associated with a chunk in the logical volume for thin provisioning is zero data.

The zero data is data in a state of being initialized or logically deleted. The zero data is data in which bit values “0” are lined, for example. The zero data is not limited to the data in which bit values “0” are lined as long as the data is in the state of being initialized or logically deleted. This makes the determination unit 602 to be capable of determining whether or not the chunk, to which the data is to be migrated, is a chunk to which a physical area does not have to be allocated.

The migration unit 603 migrates the data read by the read unit 601 to the migration destination logical volume 121. For example, the migration unit 603 migrates a predetermined amount of data, which is received by the read unit 601 from the migration source storage device 201, to the migration destination logical volume 121 included in the migration source storage device 201. In this way, the migration unit 603 is capable of migrating the data to the migration destination logical volume 121.

When the determination unit 602 determines that the storage area in the migration source logical volume 111 is not a free space, the migration unit 603 may allocate a physical area to the storage area in the migration destination logical volume 121 associated with the storage area in the migration source logical volume 111, for example. In addition, the migration unit 603 may migrate the data read by the read unit 601 from the storage area in the migration source logical volume 111 to the storage area in the migration destination logical volume 121, for example. To be specific, the migration unit 603 allocates a physical area to the chunk in the migration destination logical volume 121 associated with the migration source logical volume 111. In this way, the migration unit 603 is capable of migrating the data to the migration destination logical volume 121.

When the determination unit 602 determines that the storage area in the migration source logical volume 111 is a free space, the migration unit 603 may allocate no physical area to the storage area in the migration destination logical volume 121 associated with the storage area in the migration source logical volume 111, for example. To be specific, the migration unit 603 allocates no physical area to the chunk in the migration destination logical volume 121 associated with the migration source logical volume 111. This makes the migration unit 603 to be capable of migrating the zero data to the migration destination logical volume 121 merely in appearance, thereby suppressing increase in the physical area allocated to the migration destination logical volume 121.

The update unit 604 updates the first information d1 at every moment the data is migrated to the migration destination logical volume 121. For example, when a predetermined amount of data is migrated to the migration destination logical volume 121, the update unit 604 updates the first information d1 by adding a value of a predetermined amount of the sector to the LBA value of the field for the migrated LBA in the migration management table 500. In this way, the update unit 604 is capable of making it possible to specify the position of the data to be migrated next and also making it possible to specify the migrated capacity. Hence, the update unit 604 is capable of updating the progress of the data migration.

When the determination unit 602 determines that the storage area in the migration source logical volume 111 is a free space, the update unit 604 updates the first information d1. When the determination unit 602 determines that the storage area in the migration source logical volume 111 is a free space, the update unit 604 updates the first information d1 by adding a value of the sector of the free space to the LBA value of the field for the migrated LBA in the migration management table 500, for example. In this way, the update unit 604 is capable of making it possible to specify the position of the data to be migrated next and the migrated capacity. Hence, the update unit 604 is capable of updating the progress of the data migration.

Based on the first information d1 and the second information d2 included in the migration management information stored in the storage unit, the determination unit 602 manages the progress of the data migration, and determines whether or not the capacity migrated from the migration source logical volume 111 is equal to or greater than the capacity of the migration source logical volume 111. The second information d2 is the information indicating the capacity of the migration source logical volume 111. For example, the second information d2 is the capacity of the migration source logical volume 111 of a field for the migration source volume capacity in the migration management table 500.

The determination unit 602 calculates the capacity migrated from the migration source logical volume 111 by multiplying the number indicated by the first information d1 by a unit length, and determines whether or not the capacity migrated from the migration source logical volume 111 is equal to or greater than the capacity of the migration source logical volume 111, for example. To be specific, the determination unit 602 obtains the LBA value from the field of the migrated LBA in the migration management table 500, and calculates the migrated capacity by multiplying the thus obtained LBA value by the size of the sector. Then, to be specific, the determination unit 602 obtains the capacity of the migration source logical volume 111 from the field for the migration source volume capacity in the migration management table 500, and determines whether or not the migrated capacity is equal to or greater than the capacity of the migration source logical volume 111. In this way, the determination unit 602 is capable of determining whether or not the data migration is completed and of managing the progress of the data migration.

When the determination unit 602 determines that the capacity migrated from the migration source logical volume 111 is equal to or greater than the capacity of the migration source logical volume 111, the read unit 601 terminates the reading of the data. When the determination unit 602 determines that the migrated capacity is equal to or greater than the capacity of the migration source logical volume 111, the read unit 601 assumes that the data migration from the migration source logical volume 111 is completed, thereby terminating the reading of the data. In this way, the read unit 601 is capable of terminating the reading of the data to terminate the data migration when the data migration is completed.

In addition, when the request for reading the data of one or more sectors counted from the beginning of the sector indicated by any LBA value is issued to the migration source storage device 201, the read unit 601 may detect an error indicating that there is no data of any of the sectors. In addition, when the error is detected, the read unit 601 may terminate the reading of the data. For example, when an error, which indicates that the area to be read, which is designated by the read request, is not in the migration source logical volume 111, the read unit 601 terminates the reading of the data.

When the request for reading the data of one or more sectors from the beginning of the sector indicated by any LBA value is received, the migration source storage device 201 returns data, which is succeeded to be read, out of the data of the one or more sectors, for example. In addition, when there is data, which is not in the migration source logical volume 111 and fails to be read, out of the data of one or more sectors, the migration source storage device 201 returns an error indicating that there is no data. The case where no data is in the migration source logical volume 111 is a case of receiving the read request from the sector indicated by the LBA value greater than the latest LBA in the migration source logical volume 111, for example.

To be specific, when the error indicating that the area to be read, which is designated by the read request, is not in the migration source logical volume 111 is outputted from the migration source storage device 201, the read unit 601 terminates the reading of the data. This makes the read unit 601 to terminate the reading of the data when the data migration is completed, even when there is no determination processing of the determination unit 602.

When the determination unit 602 determines that the capacity migrated from the migration source logical volume 111 is equal to or greater than the capacity of the migration source logical volume 111, the update unit 604 deletes the first information d1 and the second information d2. When the determination unit 602 determines that the migrated capacity is equal to or greater than the capacity of the migration source logical volume 111, the update unit 604 deletes a slave table associated with the migration source logical volume 111 in the migration management table 500. This makes the update unit 604 to be capable of making possible to efficiently utilize the storage area.

The reception unit 605 receives the request for reading the data from the migration source logical volume 111. For example, the reception unit 605 receives from the host device 203 the request for reading the data in the sector of any LBA in the migration source logical volume 111. This makes the reception unit 605 to be capable of making possible to specify the sector including the data to be read.

The reception unit 605 receives the request for writing the data to the migration source logical volume 111. For example, the reception unit 605 receives from the host device 203 the request for writing the data in the sector of any LBA in the migration source logical volume 111. This makes the reception unit 605 to be capable of making possible to specify the sector to which the data is to be written.

When the reception unit 605 receives the request for reading the data from the migration source logical volume 111, the processing unit 606 determines whether or not the data requested to be read has been migrated to the migration destination logical volume 121 based on the first information d1. For example, when the LBA value of the sector including the data requested to be read is less than the LBA value of the field for the migrated LBA in the migration management table 500, the processing unit 606 determines that the data has been migrated.

When the data is determined to have not been migrated yet, the processing unit 606 reads the data requested to be read from the migration source logical volume 111. For example, the processing unit 606 issues the read request to the migration source storage device 201, thereby receiving the data requested to be read in the migration source logical volume 111 included in the migration source storage device 201. This makes the processing unit 606 to be capable of responding to a computer that transmits the read request.

When the data is determined to be migrated, the processing unit 606 reads the data requested to be read from the migration destination logical volume 121. For example, the processing unit 606 reads the data requested to be read from the migration destination logical volume 121 included in the migration destination storage device 202. In this way, when the data requested to be read is in the migration destination logical volume 121, the processing unit 606 is capable of responding to the transmission source computer by reading the data from the migration destination logical volume 121. This achieves decrease in time to respond.

When the reception unit 605 receives the request for writing the data to the migration source logical volume 111, the processing unit 606 writes the data requested to be written to the migration source logical volume 111 and the migration destination logical volume 121. For example, the processing unit 606 issues the write request to the migration source storage device 201, thereby making the migration source storage device 201 to write the data requested to be written to the migration source logical volume 111 included in the migration source storage device 201.

In addition, the processing unit 606 writes the data requested to be written to the migration destination logical volume 121 included in the migration destination storage device 202, for example. This makes the processing unit 606 to be capable of writing the data requested to be written in such a way as to maintain consistency between the migration source logical volume 111 and the migration destination logical volume 121.

### Operation Example 1 of Migration Destination Storage Device 202

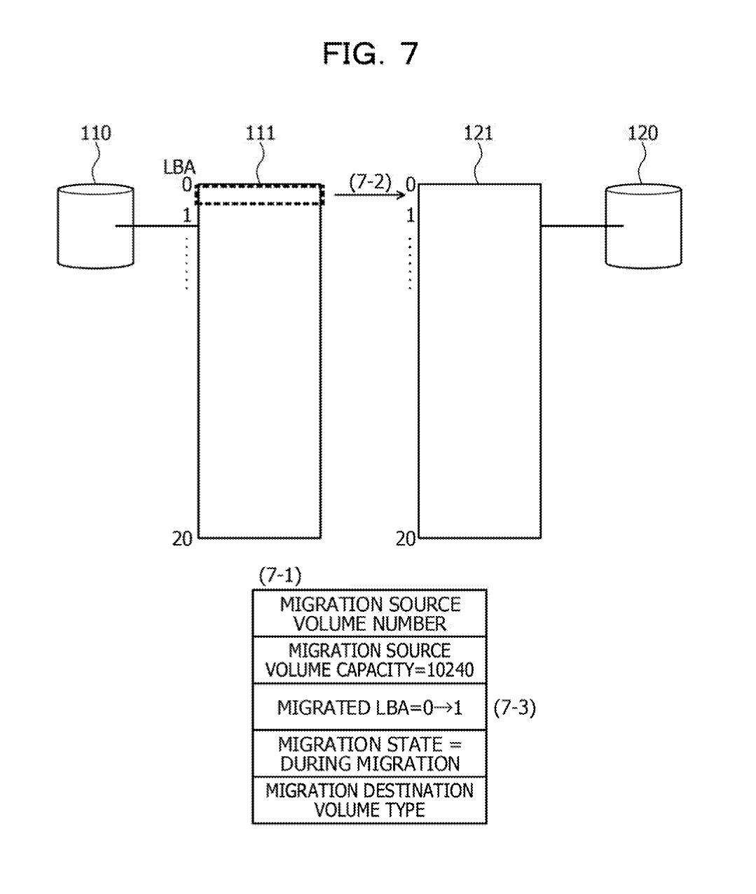

Next, an operation example 1 of the migration destination storage device 202 is described with reference to FIG. 7 to FIG. 13. The operation example 1 is an example of a case where the migration destination logical volume 121 is not the logical volume for thin provisioning. In the description below, the migration destination storage device 202 may be simply referred to as “storage device 202”.

FIG. 7 is an explanatory diagram (part 1) illustrating an example of migrating the data according to the operation example 1. In the example in FIG. 7, the migration source logical volume 111 is implemented by the migration source storage device 110 included in the migration source storage device 201. The migration source storage device 110 is one or more devices 320 illustrated in FIG. 3, for example. To be specific, the migration source storage device 110 is one or more disks.

The migration destination logical volume 121 is implemented by the migration destination storage device 120 included in the storage device 202 operated as the storage control device 100. The migration destination storage device 120 is one or more devices 320 illustrated in FIG. 3, for example. To be specific, the migration destination storage device 120 is one or more disks.

(7-1) The storage device 202 creates the migration management table 500 and initializes the migration management table 500. Here, a case where the number of the migration source logical volume 111 is one is described for simplifying the description.

The storage device 202 communicates with the migration source storage device 201, thereby obtaining a number for identifying the migration source logical volume 111 included in the migration source storage device 201 and the capacity of the migration source logical volume 111 “10240 KB”, for example. The storage device 202 sets the thus obtained number for identifying the migration source logical volume 111 and the capacity of the migration source logical volume 111 “10240 KB” in the fields for the migration source volume number and the migration source volume capacity in the migration management table 500, respectively.

At this time, the storage device 202 may generate the migration destination logical volume 121 with the same capacity as the thus obtained capacity of the migration source logical volume 111 “10240 KB”, and may allocate physical areas to the entire migration destination logical volume 121.

The storage device 202 sets “0” in the field for the migrated LBA in the migration management table 500, for example. In addition, the storage device 202 sets “during migration” in the field for the migration state in the migration management table 500, for example. Moreover, the storage device 202 sets information, which indicates that the migration destination logical volume 121 included in its own device is not the logical volume for thin provisioning, in the field for the migration destination volume type in the migration management table 500, for example. Then, the storage device 202 starts the data migration from the migration source volume.

(7-2) The storage device 202 obtains LBA “0” from the field for the migrated LBA in the migration management table 500. The storage device 202 reads a predetermined amount of the data from the beginning of the sector with the LBA “0” in the migration source logical volume 111 and migrates the data to the migration destination logical volume 121. For example, the storage device 202 reads 512 KB of data from the beginning of the sector with the LBA “0” in the migration source logical volume 111 and starts writing the data from the beginning of the sector with the LBA “0” in the migration destination logical volume 121.

To be specific, the storage device 202 transmits the request for reading 512 KB of data from the beginning of the sector with the LBA “0” in the migration source logical volume 111, to the migration source storage device 201. As a result, the storage device 202 receives such data from the migration source storage device 201 and starts writing the thus received data from the beginning of the sector with the LBA “0” in the migration destination logical volume 121.

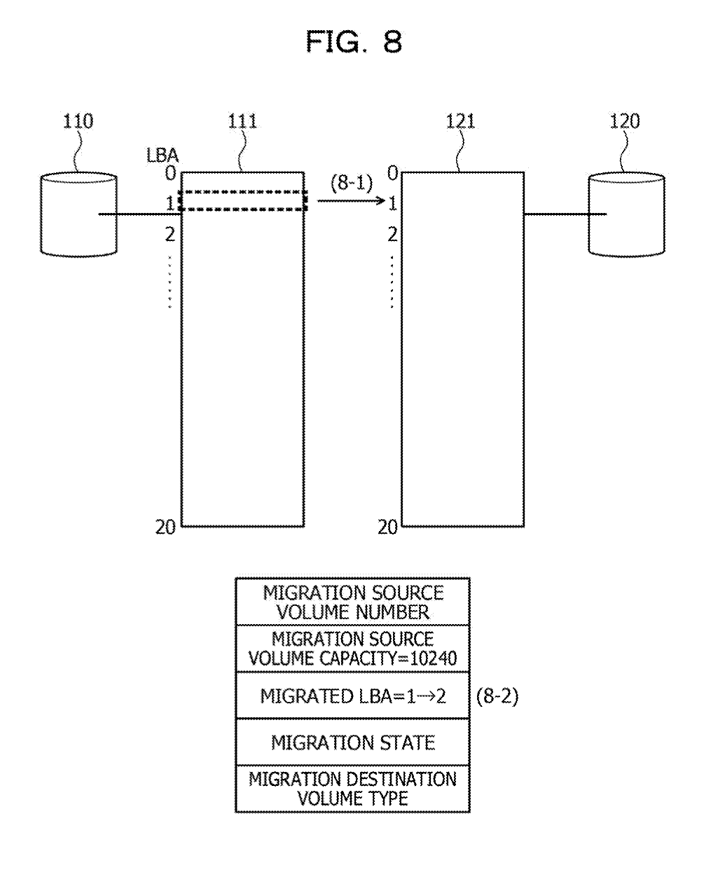

(7-3) After migrating the data to the migration destination logical volume 121, the storage device 202 adds the number of the sector for the size of the migrated data to the thus obtained LBA “0”, and sets the sum in the field for the migrated LBA in the migration management table 500. For example, when migrating 512 KB of data, the storage device 202 adds the number of the sector for 512 KB “1” to LBA “0”, and sets the sum in the field for the migrated LBA in the migration management table 500. Now, the description proceeds to a description of FIG. 8.

FIG. 8 is an explanatory diagram (part 2) illustrating the example of data migration according to the operation example 1. In the example in FIG. 8, (8-1) the storage device 202 obtains LBA “1” from the field for the migrated LBA in the migration management table 500. The storage device 202 reads a predetermined amount of the data from the beginning of the sector with the LBA “1” in the migration source logical volume 111, and migrates the data to the migration destination logical volume 121. For example, the storage device 202 reads 512 KB of data from the beginning of the sector with the LBA “1” in the migration source logical volume 111, and starts writing the data from the beginning of the sector with the LBA “1” in the migration destination logical volume 121. To be specific, the storage device 202 transmits the request for reading 512 KB of data from the beginning of the sector with the LBA “1” in the migration source logical volume 111 to the migration source storage device 201, thereby receiving such data from the migration source storage device 201 and starting to write.

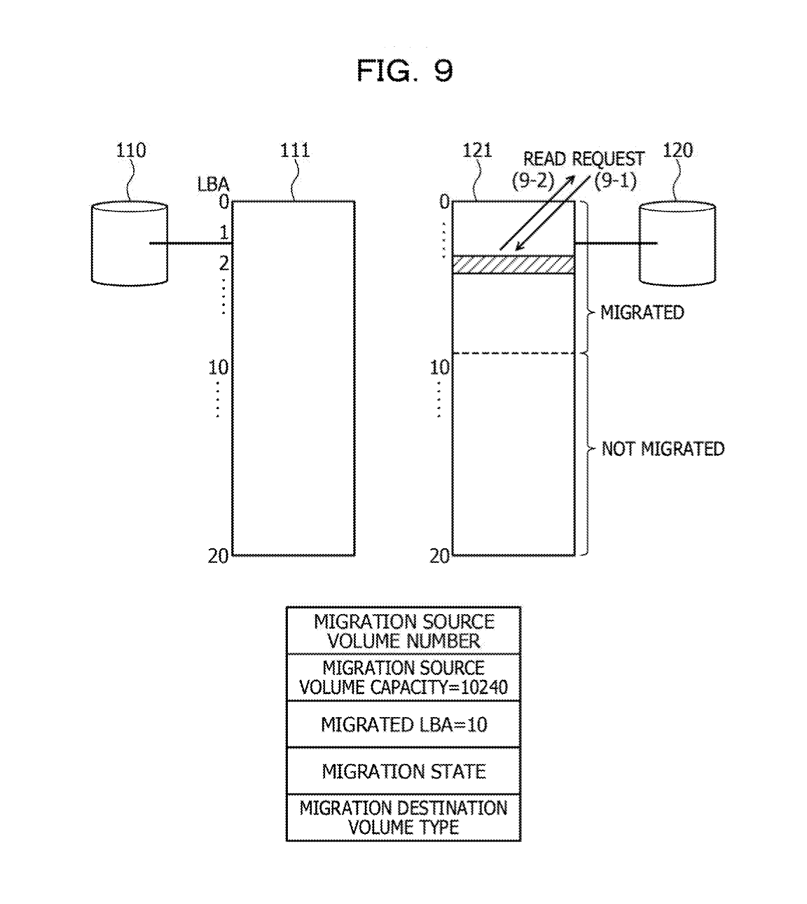

(8-2) After migrating the data to the migration destination logical volume 121, the storage device 202 adds the number of the sector for the size of the migrated data to the thus obtained LBA “1”, and sets the sum in the field for the migrated LBA in the migration management table 500. For example, when migrating 512 KB of data, the storage device 202 adds the number of the sector for 512 KB “1” to the LBA “1”, and sets the sum in the field for the migrated LBA in the migration management table 500. After that, the storage device 202 migrates the data in the migration source volume in the same way. Now, the description proceeds to descriptions of FIG. 9 to FIG. 12, and a case of receiving the read request and the write request during the data migration is described.

FIG. 9 is an explanatory diagram (part 1) illustrating the read processing during the data migration according to the operation example 1. In the example in FIG. 9, it is assumed that data with an amount counted from the beginning of the migration source logical volume 111 to the beginning of the sector with LBA “10” has been migrated to the migration destination logical volume 121, and the storage device 202 receives the data read request in any sector preceding the sector with the LBA “10”.

(9-1) After receiving the read request, the storage device 202 obtains the LBA “10” from the field for the migrated LBA in the migration management table 500. The storage device 202 determines whether or not the data requested to be read is in a region for migrated data based on the thus obtained LBA “10”. For example, the storage device 202 determines that the data requested to be read is in the region for migrated data when the LBA of the sector including the data requested to be read is less than the thus obtained LBA “10”.

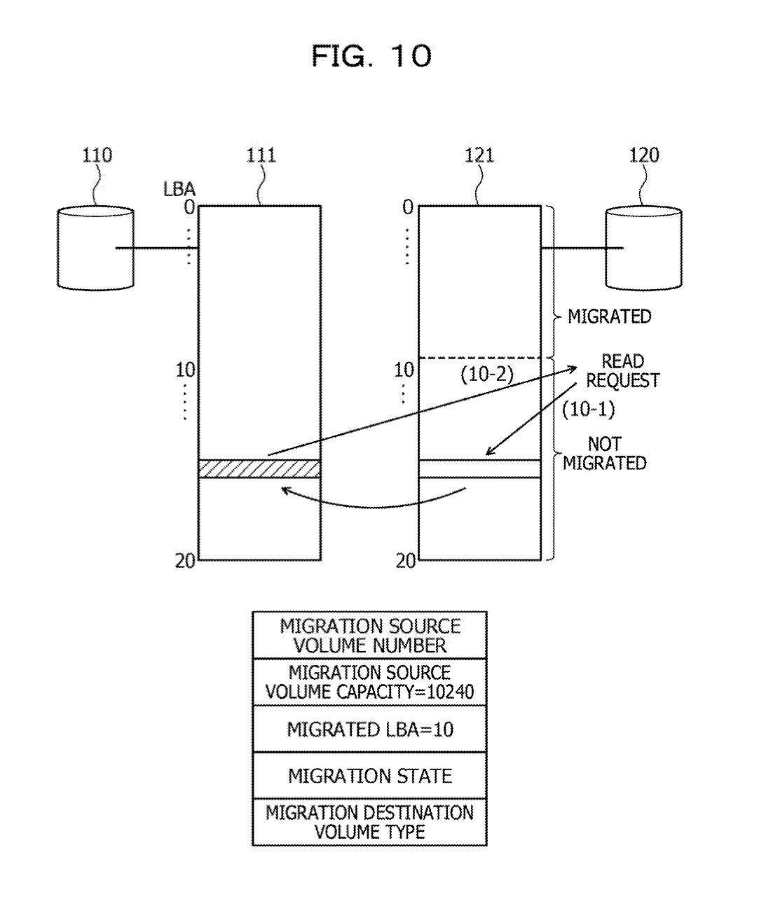

(9-2) The storage device 202 determines that the data requested to be read is in the region for migrated data because the data requested to be read is in the sector preceding the sector with the LBA “10”. Then, after determining that the data requested to be read is in the region for migrated data, the storage device 202 reads the data requested to be read from the migration destination logical volume 121 included in its own device, and transmits the data to the host device 203. Now, the description proceeds to a description of FIG. 10.

FIG. 10 is an explanatory diagram (part 2) illustrating the read processing during the data migration according to the operation example 1. In the example in FIG. 10, it is assumed that the data with the amount counted from the beginning of the migration source logical volume 111 to the beginning of the sector with the LBA “10” has been migrated to the migration destination logical volume 121, and the storage device 202 receives the data read request in any sector following the sector with the LBA “10”.

(10-1) After receiving the read request, the storage device 202 obtains the LBA “10” from the field for the migrated LBA in the migration management table 500. The storage device 202 determines whether or not the data requested to be read is in the region for migrated data based on the thus obtained LBA “10”. For example, the storage device 202 determines that the data requested to be read is not in the region for migrated data when the LBA of the sector including the data requested to be read is equal to or greater than the thus obtained LBA “10”.

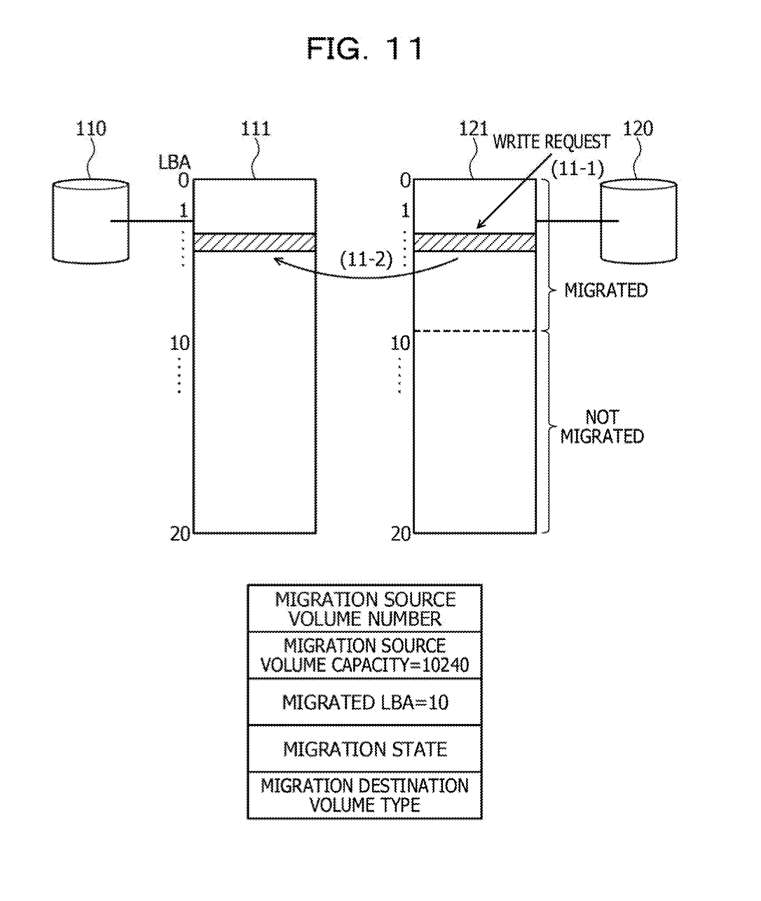

(10-2) The storage device 202 determines that the data requested to be read is not in the region for migrated data because the data requested to be read is in the sector following the sector with the LBA “10”. Then, after determining that the data requested to be read is not in the region for migrated data, the storage device 202 transmits the read request for the data requested to be read to the migration source storage device 201, thereby receiving such data from the determination source storage device 201 and transmitting the data to the host device 203. Now, the description proceeds to a description of FIG. 11.

FIG. 11 is an explanatory diagram (part 1) illustrating the write processing during the data migration according to the operation example 1. In the example in FIG. 11, it is assumed that the data with the amount counted from the beginning of the migration source logical volume 111 to the beginning of the sector with the LBA “10” is to be migrated to the migration destination logical volume 121. In addition, it is assumed that the storage device 202 receives the write request to write the data to a position preceding the sector with the LBA “10”.

(11-1) After receiving the write request, the storage device 202 obtains the LBA “10” from the field for the migrated LBA in the migration management table 500. The storage device 202 determines whether or not the position to which the data is to be written is in the region for migrated data based on the thus obtained LBA “10”. For example, the storage device 202 determines that the position to which the data is to be written is in the region for migrated data when the LBA of the sector for writing the data requested to be written is less than the thus obtained LBA “10”.

(11-2) The storage device 202 determines that the position to which the data is to be written is in the region for migrated data because the position to which the data is to be written precedes the sector with the LBA “10”. Then, after determining that the position to which the data is to be written is in the region for migrated data, the storage device 202 writes the data requested to be written to the migration destination logical volume 121 included in its own device.

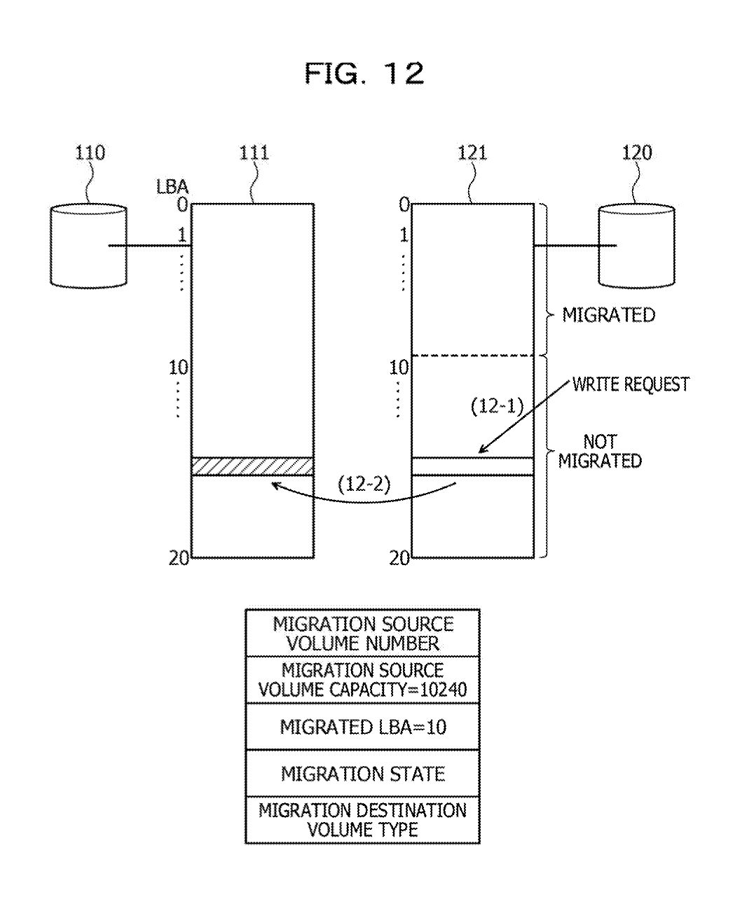

In addition, the storage device 202 transmits the write request to the migration source storage device 201, thereby making the migration source storage device 201 to write the data requested to be written also to the migration source logical volume 111. After terminating the writing of the data requested to be written to the migration destination logical volume 121 included in the storage device 202 and the migration source logical volume 111, the storage device 202 returns writing success to the host device 203. Now, the description proceeds to a description of FIG. 12.

FIG. 12 is an explanatory diagram (part 2) illustrating the write processing during the data migration according to the operation example 1. In the example in FIG. 12, it is assumed that the data with the amount counted from the beginning of the migration source logical volume 111 to the beginning of the sector with the LBA “10” is to be migrated to the migration destination logical volume 121. In addition, it is assumed that the storage device 202 receives the write request to write the data to a position following the sector with the LBA “10”.

(12-1) After receiving the write request, the storage device 202 obtains the LBA “10” from the field for the migrated LBA in the migration management table 500. The storage device 202 determines whether or not the position to which the data is to be written is in the region for migrated data based on the thus obtained LBA “10”. For example, the storage device 202 determines that the position to which the data is to be written is not in the region for migrated data when the LBA of the sector for writing the data requested to be written is greater than the thus obtained LBA “10”.

(12-2) The storage device 202 determines that the position to which the data is to be written is not in the region for migrated data because the position to which the data is to be written follows the sector with the LBA “10”. Then, after determining that the position to which the data is to be written is not in the region for migrated data, the storage device 202 transmits the write request to the migration source storage device 201, thereby making the migration source storage device 201 to write the data requested to be written to the migration source logical volume 111.

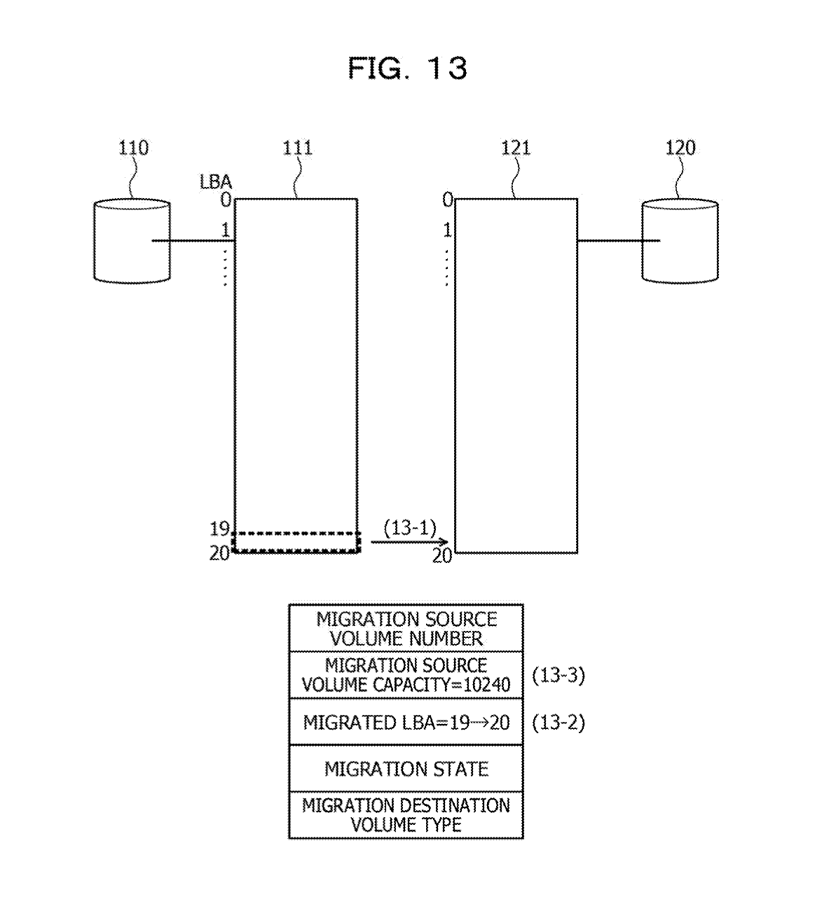

The storage device 202 may also write the data requested to be written to the migration destination logical volume 121 included in its own device. After terminating the writing of the data requested to be written to the migration source logical volume 111, the storage device 202 returns writing success to the host device 203. Now, the description proceeds to a description of FIG. 13.

FIG. 13 is an explanatory diagram illustrating an example of determination to terminate the migration according to the operation example 1. In the example in FIG. 13, (13-1) the storage device 202 obtains LBA “19” from the field for the migrated LBA in the migration management table 500. The storage device 202 reads a predetermined amount of the data from the beginning of the sector with the LBA “19” in the migration source logical volume 111, and migrates the data to the migration destination logical volume 121. For example, the storage device 202 reads 512 KB of data from the beginning of the sector with the LBA “19” in the migration source logical volume 111, and starts writing the data from the beginning of the sector with the LBA “19” in the migration destination logical volume 121. To be specific, the storage device 202 transmits the read request for 512 KB of data from the beginning of the sector with the LBA “19” in the migration source logical volume 111 to the migration source storage device 201, thereby receiving such data from the migration source storage device 201 and starting to write.

(13-2) After migrating the data to the migration destination logical volume 121, the storage device 202 adds the number of the sector for the size of the migrated data to the thus obtained LBA “19”, and sets the sum in the field for the migrated LBA in the migration management table 500. For example, when migrating 512 KB of data, the storage device 202 adds the number of the sector for 512 KB “1” to the LBA “19”, and sets the sum in the field for the migrated LBA in the migration management table 500.

(13-3) The storage device 202 obtains LBA “20” from the field for the migrated LBA in the migration management table 500. In addition, the storage device 202 obtains a capacity of the migration source logical volume 111 “10240 KB” from the field for the migration source volume capacity in the migration management table 500. The storage device 202 calculates the migrated capacity of the migration source logical volume 111 “10240 KB” by multiplying the LBA “20” by the size of a sector 512 KB, and determines whether or not the result is equal to or greater than the capacity of the migration source logical volume 111 “10240 KB”.

Because the migrated capacity “10240 KB” is equal to or greater than the capacity of the migration source logical volume 111 “10240 KB”, the storage device 202 terminates the reading of the data from the migration source logical volume 111.

In this way, the storage device 202 is capable of suppressing the increase in the size of the management data, which manages the progress of the data migration, even when the capacity of the migration source logical volume 111 increases. In addition, since the bitmap is not used, when receiving the read request and the write request from the host device, the storage device 202 is capable of executing the read processing and the write processing for each set of the data having comparatively small capacity, thereby suppressing the increase in the time to respond to the host device.

The case where the number of the migration source logical volume 111 is one is described herein; however, the case is not limited to this. For example, the number of the migration source logical volume 111 may be two or more. When there are two or more migration source logical volumes 111, the storage device 202 generates slave tables of the migration management table 500 for the respective migration source logical volumes 111, and executes the data migration in the same way as the above-described operation example 1.

### Operation Example 2 of Migration Destination Storage Device 202

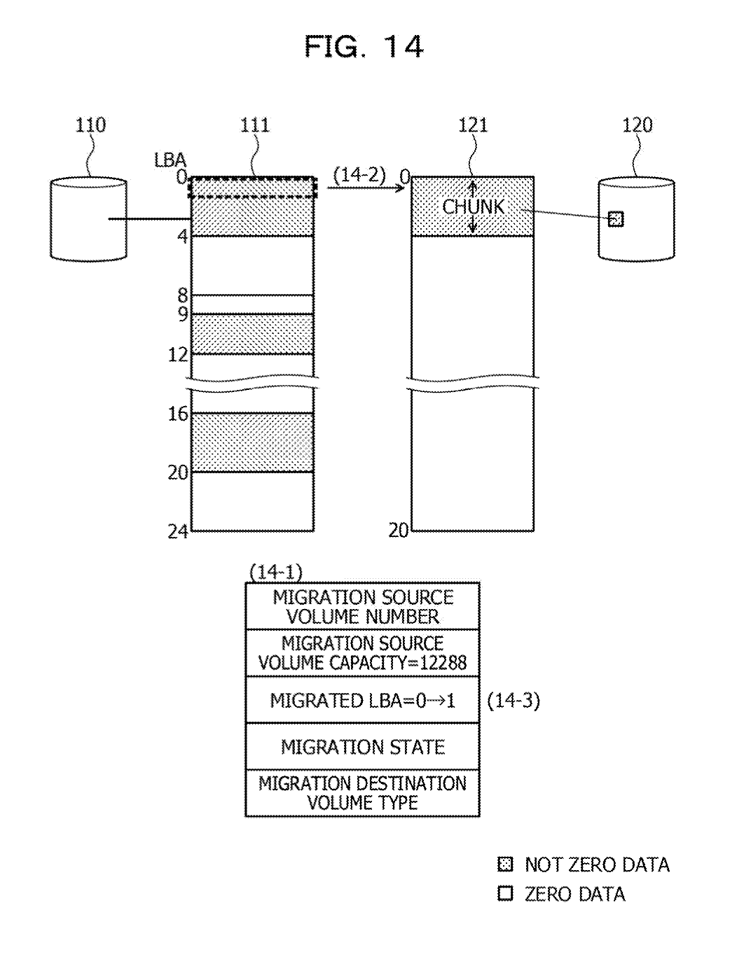

Next, the operation example 2 of the migration destination storage device 202 is described with reference to FIG. 14 to FIG. 19. The operation example 2 is an example of a case where the migration destination logical volume 121 is the logical volume for thin provisioning. In the description below, the migration destination storage device 202 may be simply referred to as “storage device 202”.

In this case, thin provisioning is a technique of dividing a logical volume in a predetermined capacity of chunk unit, and allocating no physical areas to the entire logical volume at first but allocating the physical areas when using the logical volume in the chunk unit. The chunk is 2048 KB, for example. According to thin provisioning, an apparent capacity of the logical volume may be greater than the total capacity of the physical areas allocated to the logical volume, thereby suppressing the capacities of the physical areas allocated to the logical volume.

However, once the data in the migration source logical volume 111 is migrated to the migration destination logical volume 121 as the logical volume for thin provisioning, physical areas may be allocated to the entire migration destination logical volume 121. For example, even when the storage area in the migration source logical volume 111 that is associated with any chunk in the migration destination logical volume 121 is not in use, zero data may be undesirably migrated to such a storage area.

As a result, even in the case where the storage area in the migration source logical volume 111 associated with any chunk in the migration destination logical volume 121 is not in use and the physical areas do not have to be allocated to such a chunk, the physical areas are allocated to write the zero data thereto. Then, such allocation of the physical areas to the entire migration destination logical volume 121 causes increase in the size of the physical areas allocated to the migration destination logical volume 121.

In the operation example 2, the storage device 202 migrates the data in the migration source logical volume 111 to the migration destination logical volume 121 in such a way as to suppress the increase in the size of the physical areas allocated to the migration destination logical volume 121. Now, the description proceeds to a description of FIG. 14.

FIG. 14 is an explanatory diagram (part 1) illustrating an example of the data migration according to the operation example 2. In the example in FIG. 14, the migration source logical volume 111 is implemented by the migration source storage device 110 included in the migration source storage device 201. For example, the migration source storage device 110 is one or more devices 320 illustrated in FIG. 3. To be specific, the migration source storage device 110 is one or more disks.

The migration destination logical volume 121 is implemented by the migration destination storage device 120 included in the storage device 202 that is operated as the storage control device 100. For example, the migration destination storage device 120 is one or more devices 320 illustrated in FIG. 3. To be specific, the migration destination storage device 120 is one or more disks.

(14-1) The storage device 202 creates the migration management table 500, and initiates the migration management table 500. Here, a case where the number of the migration source logical volume 111 is one is described for simplifying the description.

The storage device 202 communicates with the migration source storage device 201, thereby obtaining a number for identifying the migration source logical volume 111 included in the migration source storage device 201 and the capacity of the migration source logical volume 111 “12288 KB”, for example. The storage device 202 sets the thus obtained number for identifying the migration source logical volume 111 and the capacity of the migration source logical volume 111 “12288 KB” in the fields for the migration source volume number and the migration source volume capacity in the migration management table 500, respectively.

At this time, the storage device 202 generates the migration destination logical volume 121 that has the same capacity as the thus obtained capacity of the migration source logical volume 111 “12288 KB”. Meanwhile, at this time, the storage device 202 does not allocate physical areas to the thus generated migration destination logical volume 121.

In addition, for example, the storage device 202 sets “0” in the field for the migrated LBA in the migration management table 500. Moreover, for example, the storage device 202 sets “during migration” in the field for the migration state in the migration management table 500. Further, for example, the storage device 202 sets information, which indicates that the migration destination logical volume 121 included in its own device is the logical volume for thin provisioning, in the field for the migration destination volume type in the migration management table 500. Then, the storage device 202 starts the data migration from the migration source volume.

(14-2) The storage device 202 obtains LBA “0” from the field for the migrated LBA in the migration management table 500. The storage device 202 reads a predetermined amount of the data from the beginning of the sector with the LBA “0” in the migration source logical volume 111. For example, the storage device 202 transmits to the migration source storage device 201 the request for reading 512 KB of data counted from the beginning of the sector with the LBA “0” in the migration source logical volume 111, thereby receiving such data from the migration source storage device 201.

The storage device 202 determines whether or not the beginning of the sector with the LBA “0” in the migration destination logical volume 121, to which the predetermined amount of the read data is migrated, is the beginning of the chunk. Here, the storage device 202 determines that the beginning of the sector is the beginning of the chunk. After determining that the beginning of the sector is the beginning of the chunk, the storage device 202 determines whether or not the predetermined amount of the read data is zero data. Here, the storage device 202 determines that the data is not zero data.

After determining that the data is not zero data, the storage device 202 allocates a physical area to the chunk started from the beginning of the sector with the LBA “0”. The storage device 202 migrates the predetermined amount of the read data to the chunk started from the beginning of the sector with the LBA “0”, to which the physical area is allocated, in the migration destination logical volume 121.

(14-3) After migrating the data to the migration destination logical volume 121, the storage device 202 adds the number of the sector for the size of the migrated data to the thus obtained LBA “0”, and sets the sum in the field for the migrated LBA in the migration management table 500. For example, when migrating 512 KB of data, the storage device 202 adds the number of the sector for 512 KB “1” to the LBA “0”, and sets the sum in the field for the migrated LBA in the migration management table 500.

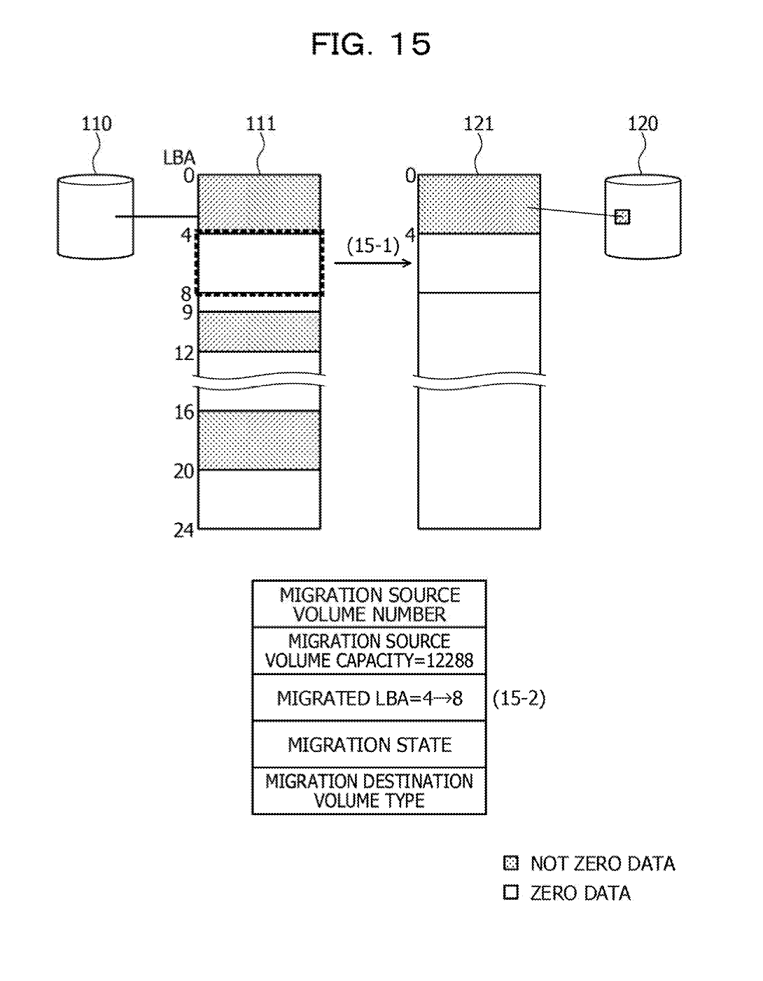

Hereinafter, it is assumed that the storage device 202 migrates data with an amount counted to the beginning of the sector with LBA “4” in the migration source logical volume 111, which is associated with the chunk started from the beginning of the sector with the LBA “0”, to the migration destination logical volume 121 in the same way. Now, the description proceeds to a description of FIG. 15.

FIG. 15 is an explanatory diagram (part 2) illustrating an example of the data migration according to the operation example 2. In the example in FIG. 15, (15-1) the storage device 202 obtains the LBA “4” from the field for the migrated LBA in the migration management table 500. The storage device 202 reads a predetermined amount of data from the beginning of the sector with the LBA “4” in the migration source logical volume 111. For example, the storage device 202 transmits to the migration source storage device 201 the request for reading 512 KB of data from the beginning of the sector with the LBA “4” in the migration source logical volume 111, thereby receiving such data from the migration source storage device 201.

The storage device 202 determines whether or not the beginning of the sector with the LBA “4” in the migration destination logical volume 121, to which the predetermined amount of the read data is migrated, is the beginning of the chunk. Here, the storage device 202 determines that the beginning of the sector is the beginning of the chunk. After determining that the beginning of the sector is the beginning of the chunk, the storage device 202 determines whether or not the predetermined amount of the read data is zero data. Here, the storage device 202 determines that the data is zero data.

After determining that the data is zero data, the storage device 202 reads each set of the predetermined amount of the data from the storage area in the migration source logical volume 111, which is associated with the chunk started from the beginning of the sector with the LBA “4”, and determines whether or not the data is zero data in the same way.

Here, the storage device 202 determines the data, which is read from the storage area in the migration source logical volume 111 associated with the chunk started from the beginning of the sector with the LBA “4”, and determines that the data is zero data. In addition, the storage device 202 does not allocate a physical area to the chunk started from the beginning of the sector with the LBA “4”.

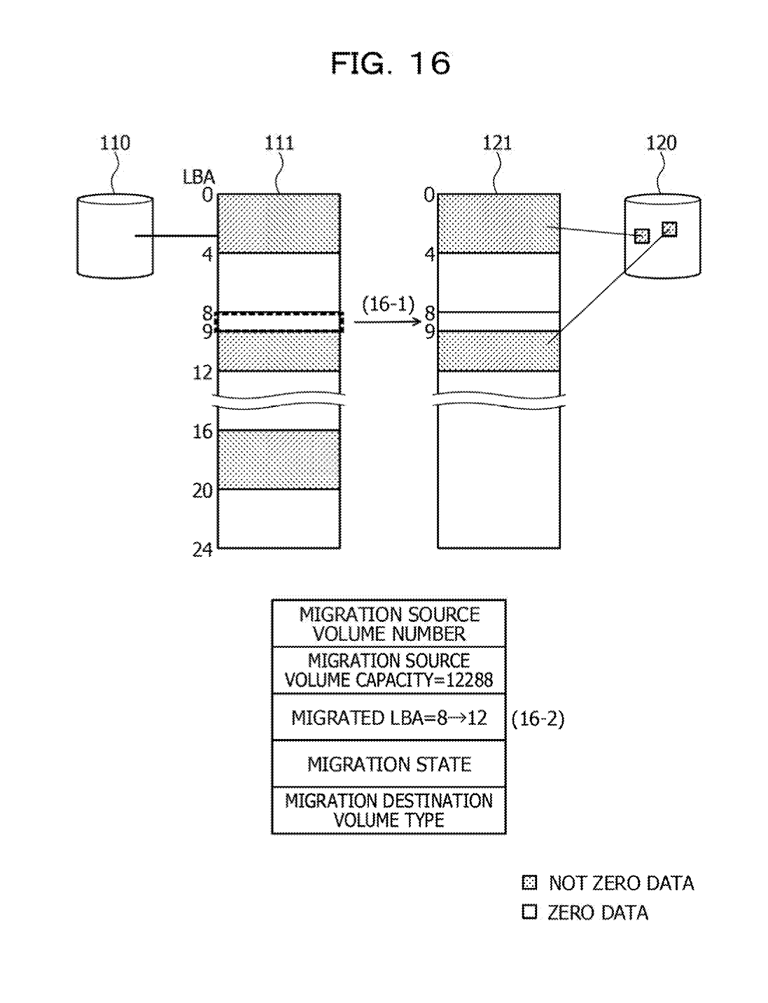

(15-2) The storage device 202 adds the number of the sectors for the size of the chunk started from the beginning of the sector with the LBA “4” to the thus obtained LBA “4”, and sets the sum in the field for the migrated LBA in the migration management table 500. For example, the storage device 202 adds the number of the sectors for 2048 KB “4” to the LBA “4”, and sets the sum in the field for the migrated LBA in the migration management table 500. Now, the description proceeds to a description of FIG. 16.

FIG. 16 is an explanatory diagram (part 3) illustrating an example of the data migration according to the operation example 2. In the example in FIG. 16, (16-1) the storage device 202 obtains LBA “8” from the field for the migrated LBA in the migration management table 500. The storage device 202 reads a predetermined amount of data from the beginning of the sector with the LBA “8” in the migration source logical volume 111. For example, the storage device 202 transmits to the migration source storage device 201 the request for reading 512 KB of data counted from the beginning of the sector with the LBA “8” in the migration source logical volume 111, thereby receiving such data from the migration source storage device 201.

The storage device 202 determines whether or not the beginning of the sector with the LBA “8” in the migration destination logical volume 121, to which the predetermined amount of the read data is migrated, is the beginning of the chunk. Here, the storage device 202 determines that the beginning of the sector is the beginning of the chunk. After determining that the beginning of the sector is the beginning of the chunk, the storage device 202 determines whether or not the predetermined amount of the read data is zero data. Here, the storage device 202 determines that the data is zero data.

After determining that the data is zero data, the storage device 202 reads each set of a predetermined amount of the data from the storage area in the migration source logical volume 111, which is associated with the chunk started from the beginning of the sector with the LBA “8”, and determines whether or not the data is zero data in the same way.

Here, the storage device 202 determines 512 KB of data counted from the beginning of the sector with the LBA “9” is not zero data. For this reason, the storage device 202 determines that the data read from the storage area in the migration source logical volume 111, which is associated with the chunk started from the beginning of the sector with the LBA “8”, includes data other than zero data.

After determining that the data includes the data other than zero data, the storage device 202 allocates a physical area to the chunk started from the beginning of the sector with the LBA “8.” The storage device 202 migrates the read zero data and the data other than zero data to the chunk started from the beginning of the sector with the LBA “8”, to which the physical area is allocated, in the migration destination logical volume 121.

(16-2) After migrating the data to the migration destination logical volume 121, the storage device 202 adds the number of the sector for the size of the migrated data to the thus obtained LBA “8”, and sets the sum in the field for the migrated LBA in the migration management table 500. For example, when migrating 2048 KB of data, the storage device 202 adds the number of the sectors for 2048 KB “4” to the LBA “8”, and sets the sum in the field for the migrated LBA in the migration management table 500.

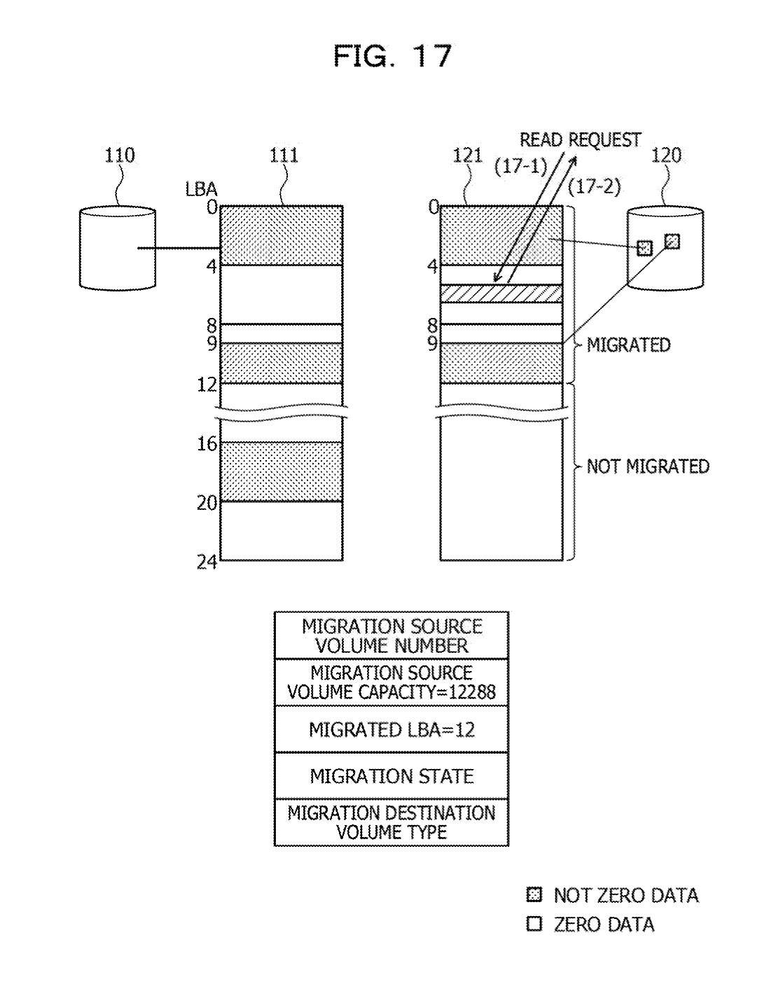

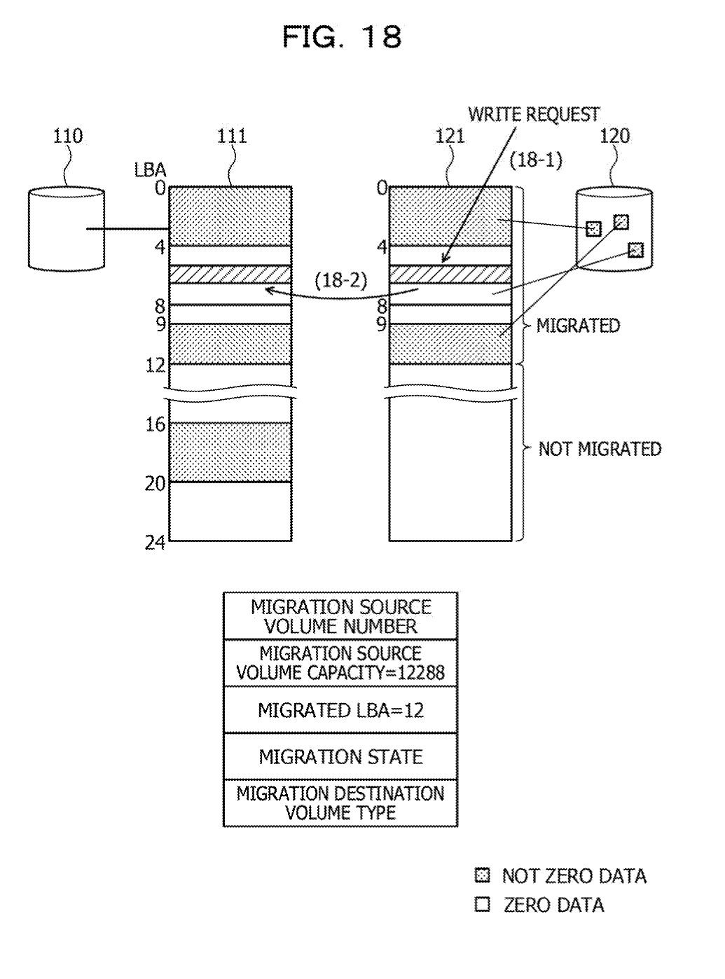

As described above, it is assumed that the storage device 202 migrates data with an amount counted to the beginning of the sector with the LBA “12” in the migrate source logical volume 111, which is associated with the chunk started from the beginning of the sector with the LBA “8”. Now, the description proceeds to descriptions of FIGS. 17 and 18, and a case of receiving the read request and the write request for data during the data migration is described.

FIG. 17 is an explanatory diagram illustrating read processing during the data migration according to the operation example 2. In the example in FIG. 17, it is assumed that data with an amount counted from the beginning of the migration source logical volume 111 to the beginning of the sector with the LBA “12” has been migrated to the migration destination logical volume 121, and the storage device 202 receives the request for reading the data preceding the sector with the LBA “12”. In addition, it is assumed that the data requested to be read in a chunk to which no physical area is allocated.

(17-1) After receiving the read request, the storage device 202 obtains the LBA “12” from the field for the migrated LBA in the migration management table 500. The storage device 202 determines whether or not the data requested to be read is in the region for migrated data based on the thus obtained LBA “12”. For example, the storage device 202 determines that the data to be read is in the region for migrated data when the LBA of the sector to which the data requested to be read is less than the thus obtained LBA “12”.

(17-2) The storage device 202 determines that the data requested to be read is in the region for migrated data because the data requested to be read precedes the sector with the LBA “12”. Then, after determining that the data requested to be read is in the region for migrated data, the storage device 202 determines whether or not the chunk including the data requested to be read is the chunk to which the physical area is allocated. Here, the storage device 202 determines that the chunk is the chunk to which no physical area is allocated. After determining that the chunk is the chunk to which no physical area is allocated, the storage device 202 transmits zero data to the host device 203. Now, the description proceeds to a description of FIG. 18.

FIG. 18 is an explanatory diagram illustrating write processing during the data migration according to the operation example 2. In the example in FIG. 18, it is assumed that the data with the amount counted from the beginning of the migration source logical volume 111 to the beginning of the sector with the LBA “12” has been migrated to the migration destination logical volume 121. In addition, it is assumed that the storage device 202 receives the write request to write the data to a position preceding the sector with the LBA “12”. Moreover, the position for writing the data requested to be written is assumed to be in the chunk to which no physical area is allocated.

(18-1) After receiving the write request, the storage device 202 obtains the LBA “12” from the field for the migrated LBA in the migration management table 500. The storage device 202 determines whether or not the position to which the data is to be written is in the region for migrated data based on the thus obtained LBA “12”. For example, the storage device 202 determines that the position to which the data is to be written is in the region for migrated data when the LBA of the sector for writing the data requested to be written is less than the thus obtained LBA “12”.

(18-2) The storage device 202 determines that the position to which the data is to be written is in the region for migrated data because the position to which the data is to be written precedes the sector with the LBA “12”. Then, after determining that the position to which the data is to be written is in the region for migrated data, the storage device 202 determines whether or not the chunk including the data requested to be read is the chunk to which the physical area is allocated. Here, the storage device 202 determines that the chunk is the chunk to which no physical area is allocated.

After determining that the chunk is the chunk to which no physical area is allocated, the storage device 202 allocates a physical area to such a chunk in the migration destination logical volume 121 included in its own device. The storage device 202 writes the data requested to be written to such a chunk, to which the physical area is allocated, in the migration destination logical volume 121 included in its own device.

In addition, the storage device 202 transmits the write request to the migration source storage device 201, thereby making the migration source storage device 201 to also write the data requested to be written to the migration source logical volume 111. After terminating the writing of the data requested to be written to the migration destination logical volume 121 included in the storage device 202 and the migration source logical volume 111, the storage device 202 returns writing success to the host device 203.

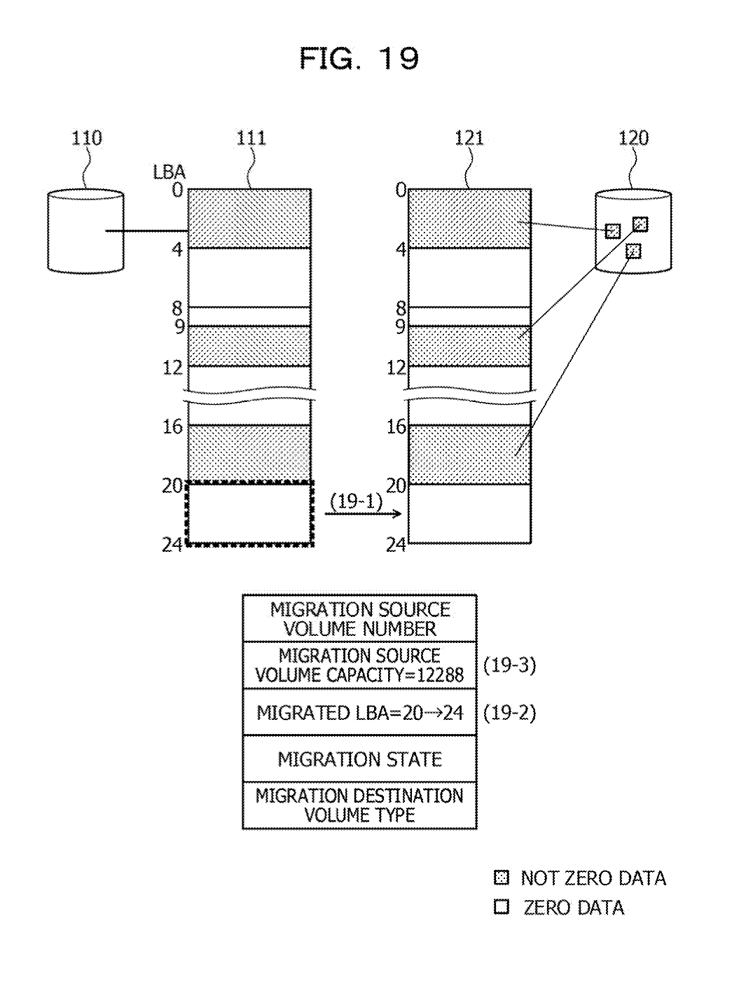

Descriptions of a case where the data requested to be read is in the chunk to which a physical area is allocated and a case where the position for writing the data requested to be written is in the chunk to which a physical area is allocated are omitted because these descriptions are same as that of FIG. 9 to FIG. 12. In addition, descriptions of a case where the data requested to be read is in a region for not migrated data, and a case where the position for writing the data requested to be written is in the region for not migrated data are also omitted because these descriptions are same as that of FIG. 9 to FIG. 12. Now, the description proceeds to a description of FIG. 19.

FIG. 19 is an explanatory diagram illustrating an example of determination to terminate the migration according to the operation example 2. In the example in FIG. 19, (19-1) the storage device 202 obtains LBA “20” from the field for the migrated LBA in the migration management table 500. The storage device 202 reads a predetermined amount of data from the beginning of the sector with the LBA “20” in the migration source logical volume 111. For example, the storage device 202 transmits to the migration source storage device 201 the request for reading 512 KB of data counted from the beginning of the sector with the LBA “20” in the migration source logical volume 111, thereby receiving such data from the migration source storage device 201.

The storage device 202 determines whether or not the beginning of the sector with the LBA “20” in the migration destination logical volume 121, to which the predetermined amount of the read data is migrated, is the beginning of the chunk. Here, the storage device 202 determines that the beginning of the sector is the beginning of the chunk. After determining that the beginning of the sector is the beginning of the chunk, the storage device 202 determines whether or not the predetermined amount of the read data is zero data. Here, the storage device 202 determines that the data is zero data.

After determining that the data is zero data, the storage device 202 reads each set of a predetermined amount of the data from the storage area in the migration source logical volume 111, which is associated with the chunk started from the beginning of the sector with the LBA “20”, and determines whether or not the data is zero data in the same way.

Here, the storage device 202 determines that the data read from the storage area in the migration source logical volume 111, which is associated with the chunk started from the beginning of the sector with the LBA “20”, is zero data. Then, the storage device 202 allocates no physical area to the chunk started from the beginning of the sector with the LBA “20”.

(19-2) The storage device 202 adds the number of the sectors for the size of the chunk started from the beginning of the sector with the LBA “20” to the thus obtained LBA “20”, and sets the sum in the field for the migrated LBA in the migration management table 500. For example, the storage device 202 adds the number of the sectors for 2048 KB “4” to the LBA “20”, and sets the sum in the field for the migrated LBA in the migration management table 500.

(19-3) The storage device 202 obtains LBA “24” from the field for the migrated LBA in the migration management table 500. In addition, the storage device 202 obtains the capacity of the migration source logical volume 111 “12288 KB” from the field for the migration source volume capacity in the migration management table 500. The storage device 202 calculates the migrated capacity “12288 KB” by multiplying the LBA “24” by the size of a sector 512 KB, and determines whether or not the result is equal to or greater than the capacity of the migration source logical volume 111 “12288 KB”. Because the migrated capacity “12288 KB” is equal to or greater than the capacity of the migration source logical volume 111 “12288 KB”, the storage device 202 terminates the reading of the data from the migration source logical volume 111.

In this way, the storage device 202 is capable of suppressing the increase in the size of the management data, which manages the progress of the data migration, even when the capacity of the migration source logical volume 111 increases. In addition, since the bitmap is not used, when receiving the read request and the write request from the host device, the storage device 202 is capable of executing the read processing and the write processing for each set of the data having comparatively small capacity, thereby suppressing the increase in the time to respond to the host device.

In addition, when the data to be migrated to any chunk in the migration destination logical volume 121 is zero data, the storage device 202 is capable of migrating zero data in appearance by allocating no physical area to such a chunk. For this reason, the storage device 202 is capable of suppressing the increase in the physical area allocated to the migration destination logical volume 121.

The case where the number of the migration source logical volume 111 is one is described herein; however, the case is not limited to this. For example, the number of the migration source logical volume 111 may be two or more. When there are two or more migration source logical volumes 111, the storage device 202 generates slave tables of the migration management table 500 for the respective migration source logical volumes 111, and executes the data migration in the same way as the above-described operation example 2.

In addition, the migration source logical volume 111 may be either the logical volume for thin provisioning or the logical volume not for thin provisioning. Even when the migration source logical volume 111 is not the logical volume for thin provisioning, the storage device 202 is capable of making the migration destination logical volume 121 to be the logical volume for thin provisioning by the data migration.

### Example of Migration Processing Procedure

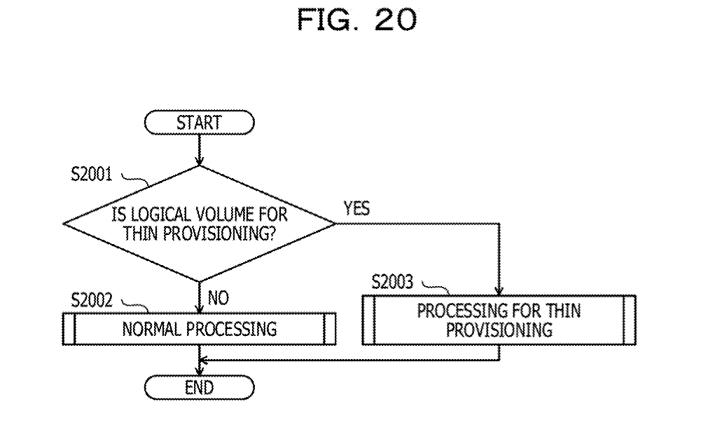

Next, an example of a migration processing procedure is described with reference to FIG. 20. Here, a case where the migration destination storage device 202 executes the migration processing is described. In the description below, the migration destination storage device 202 may be simply referred to as “storage device 202”.

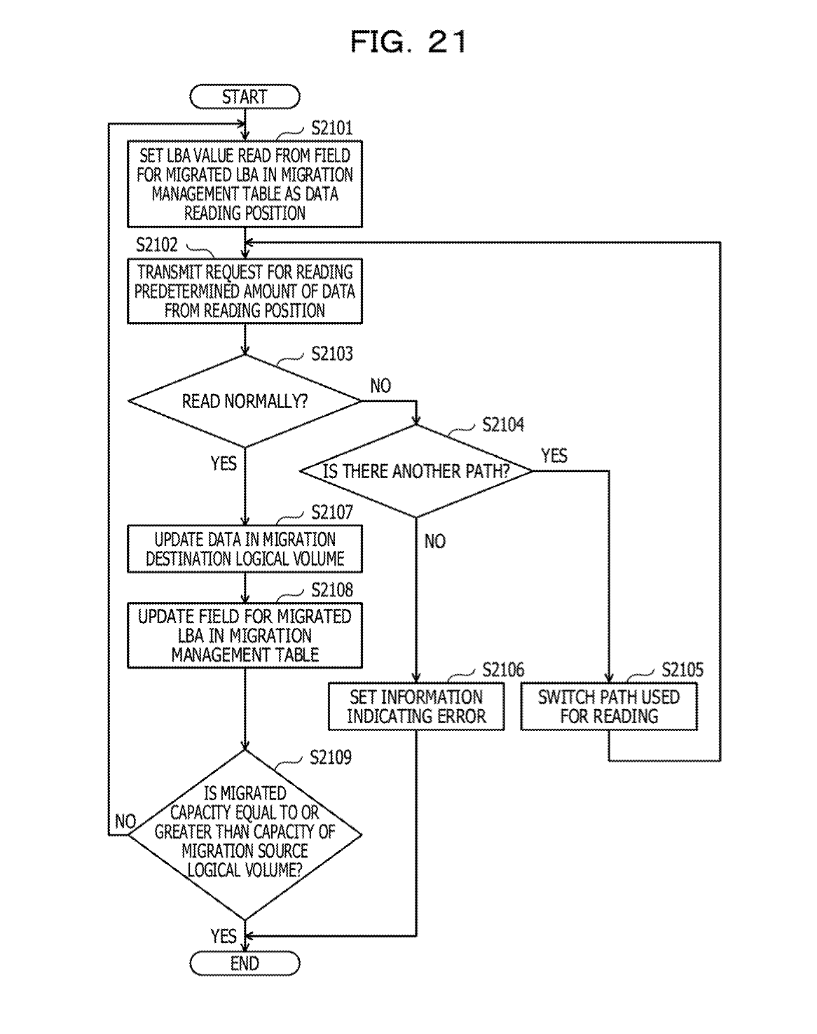

FIG. 20 is a flowchart illustrating an example of the migration processing procedure. In FIG. 20, the storage device 202 determines whether or not the migration destination logical volume 121 is the logical volume for thin provisioning (step S2001). Here, when the migration destination logical volume 121 is not the logical volume for thin provisioning (step S2001: No), the storage device 202 executes normal processing described later in FIG. 21 (step S2002). Then, the storage device 202 terminates the migration processing.

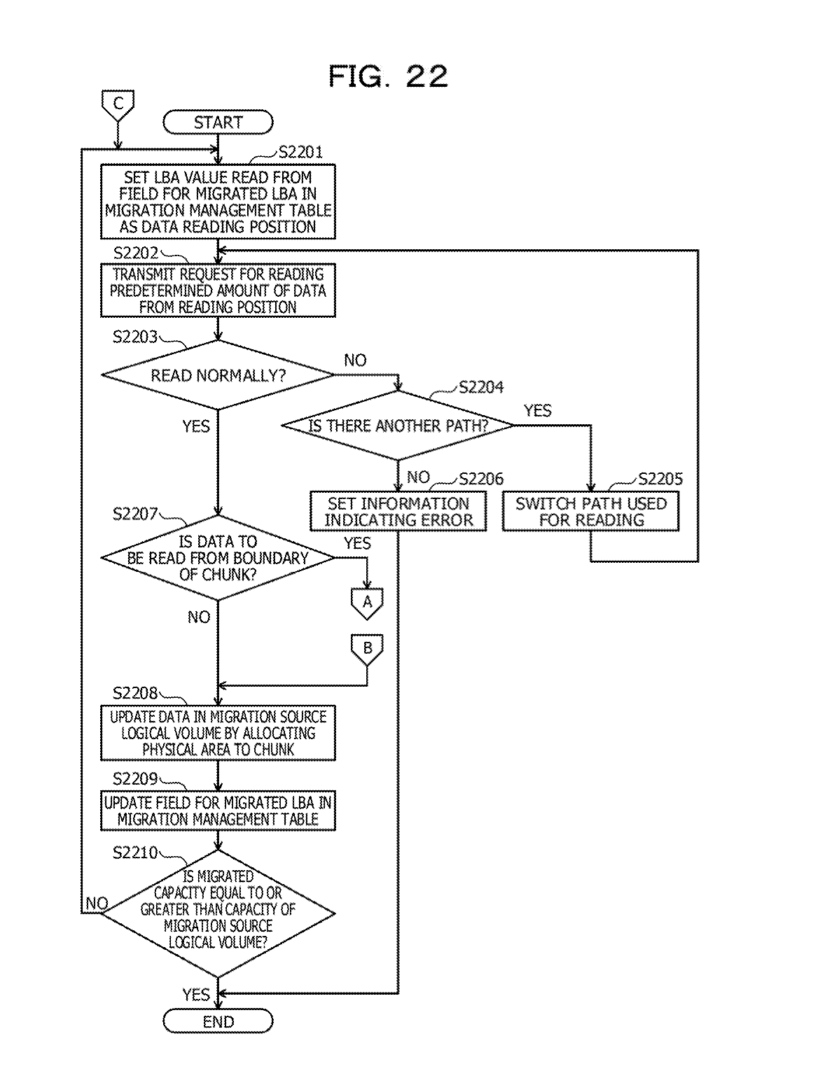

On the other hand, when the migration destination logical volume 121 is the logical volume for thin provisioning (step S2001: Yes), the storage device 202 executes processing for thin provisioning described later in FIG. 22 (step S2003). Then, the storage device 202 terminates the migration processing. In this way, the storage device 202 is capable of migrating the data.

### Example of Normal Processing Procedure

Next, an example of a normal processing procedure is described with reference to FIG. 21.

FIG. 21 is a flowchart illustrating an example of the normal processing procedure. In FIG. 21, the storage device 202 sets the LBA value read from the field for the migrated LBA in the migration management table 500 as a reading position of the data (step S2101). Next, the storage device 202 transmits to the migration source storage device 201 the request for reading a predetermined amount of data from the reading position (step S2102).

Then, the storage device 202 determines whether or not the data is normally read (step S2103). Here, when the data is not normally read (step S2103: No), the storage device 202 determines whether or not there is another path (step S2104). Here, when there is the other path (step S2104: Yes), the storage device 202 switches the path used for the reading (step S2105), and returns to the processing in step S2102.

On the other hand, when there is no other path (step S2104: No), the storage device 202 sets information indicating an error in the field for the migration state in the migration management table 500 (step S2106). Then, the storage device 202 terminates the normal processing.

Meanwhile, in step S2103, when the data is normally read (step S2103: Yes), the storage device 202 updates the data in the migration destination logical volume 121 using the read data (step S2107). Next, the storage device 202 updates the field for the migrated LBA in the migration management table 500 (step S2108).

Then, the storage device 202 reads the LBA value and the capacity of the migration source logical volume 111 from the field for the migrated LBA and the field for the migration source volume capacity in the migration management table 500, respectively. Further, the storage device 202 determines whether or not the migrated capacity is equal to or greater than the capacity of the migration source logical volume 111 (step S2109). Here, when the migrated capacity is less than the capacity of the migration source logical volume 111 (step S2109: No), the storage device 202 returns to the processing in step S2101.

On the other hand, when the migrated capacity is equal to or greater than the capacity of the migration source logical volume 111 (step S2109: Yes), the storage device 202 sets information indicating termination of the migration in the field for the migration state in the migration management table 500, and terminates the normal processing. In this way, the storage device 202 is capable of migrating the data in the migration source logical volume 111 to the migration destination logical volume 121.

### Example of Processing Procedure for Thin Provisioning

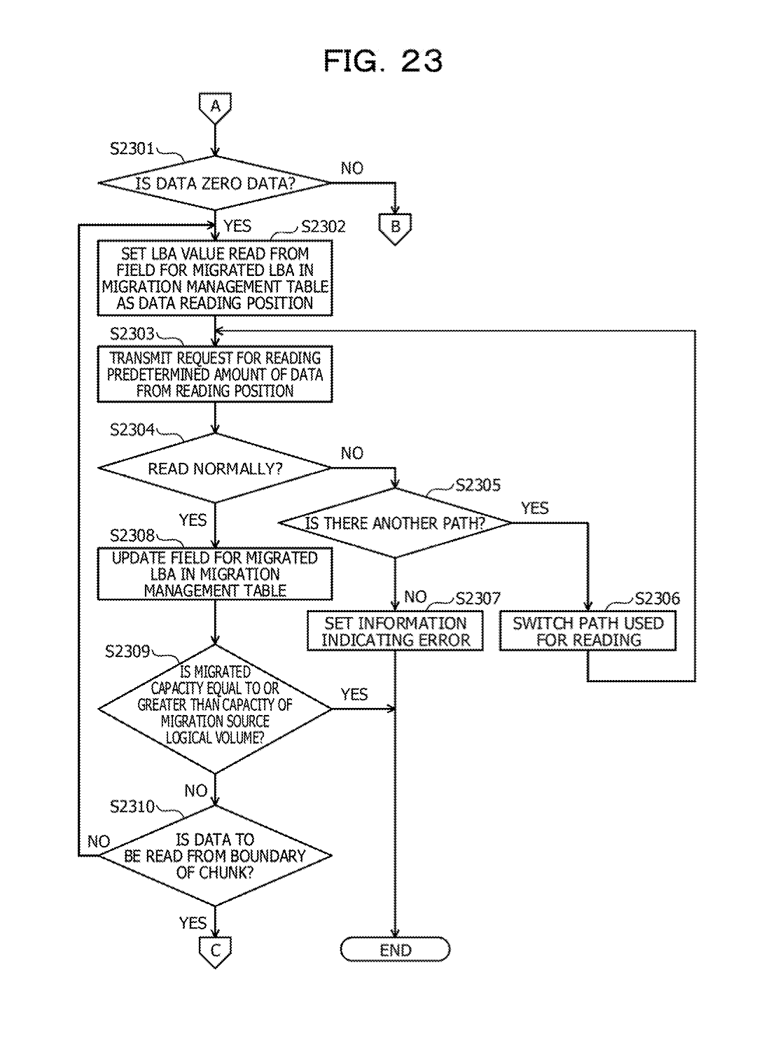

Next, an example of a processing procedure for thin provisioning is described with reference to FIG. 22 and FIG. 23.

FIG. 22 and FIG. 23 are flowcharts illustrating an example of the processing procedure for thin provisioning. In FIG. 22, the storage device 202 sets the LBA value read from the field for the migrated LBA in the migration management table 500 as a reading position of the data (step S2201). Next, the storage device 202 transmits to the migration source storage device 201 the request for reading a predetermined amount of data from the reading position (step S2202).

Then, the storage device 202 determines whether or not the data is normally read (step S2203). Here, when the data is not normally read (step S2203: No), the storage device 202 determines whether or not there is another path (step S2204). Here, when there is the other path (step S2204: Yes), the storage device 202 switches the path used for the reading (step S2205), and returns to the processing in step S2202.

On the other hand, when there is no other path (step S2204: No), the storage device 202 sets information indicating an error in the field for the migration state in the migration management table 500 (step S2206). Then, the storage device 202 terminates the processing for thin provisioning.

Meanwhile, in step S2203, when the data is normally read (step S2203: Yes), the storage device 202 determines whether or not the read data is data to be read from the boundary of the chunk (step S2207). Here, when the read data is the data to be read from the boundary of the chunk (step S2207: Yes), the storage device 202 proceeds to processing in step S2301 in FIG. 23.

On the other hand, when the read data is not the data to be read from the boundary of the chunk (step S2207: No), the storage device 202 allocates a physical area to the chunk, and updates the data in the migration destination logical volume 121 using the read data (step S2208). Next, the storage device 202 updates the field for the migrated LBA in the migration management table 500 (step S2209).

Then, the storage device 202 reads the LBA value and the capacity of the migration source logical volume 111 from the field for the migrated LBA and the field for the migration source volume capacity in the migration management table 500, respectively. Further, the storage device 202 determines whether or not the migrated capacity is equal to or greater than the capacity of the migration source logical volume 111 (step S2210). Here, when the migrated capacity is less than the capacity of the migration source logical volume 111 (step S2210: No), the storage device 202 returns to the processing in step S2201.

On the other hand, when the migrated capacity is equal to or greater than the capacity of the migration source logical volume 111 (step S2210: Yes), the storage device 202 sets information indicating termination of the migration in the field for the migration state in the migration management table 500, and terminates the processing for thin provisioning. Next, the description proceeds to a description of FIG. 23.

In FIG. 23, the storage device 202 determines whether or not the read data is zero data (step S2301). Here, when the data is not zero data (step S2301: No), the storage device 202 proceeds to the processing in step S2208 in FIG. 22.

On the other hand, when the data is zero data (step S2301: Yes), the storage device 202 sets the LBA value read from the field for the migrated LBA in the migration management table 500 as a reading position of the data (step S2302). Next, the storage device 202 transmits to the migration source storage device 201 the request for reading a predetermined amount of data from the reading position (step S2303).

Then, the storage device 202 determines whether or not the data is normally read (step S2304). Here, when the data is not normally read (step S2304: No), the storage device 202 determines whether or not there is another path (step S2305). Here, when there is the other path (step S2305: Yes), the storage device 202 switches the path used for the reading (step S2306), and returns to the processing in step S2303.

On the other hand, when there is no other path (step S2305: No), the storage device 202 sets information indicating an error in the field for the migration state in the migration management table 500 (step S2307). Then, the storage device 202 terminates the processing for thin provisioning.

Meanwhile, in step S2304, when the data is normally read (step S2304: Yes), the storage device 202 updates the field for the migrated LBA in the migration management table 500 (step S2308).

Then, the storage device 202 reads the LBA value and the capacity of the migration source logical volume 111 from the field for the migrated LBA and the field for the migration source volume capacity in the migration management table 500, respectively. Further, the storage device 202 determines whether or not the migrated capacity is equal to or greater than the capacity of the migration source logical volume 111 (step S2309).

Here, when the migrated capacity is less than the capacity of the migration source logical volume 111 (step S2309: No), the storage device 202 determines whether or not the read data is data to be read from the boundary of the chunk (step S2310). Here, when the read data is the data to be read from the boundary of the chunk (step S2310: Yes), the storage device 202 proceeds to the processing in step S2201 in FIG. 22. On the other hand, when the read data is not the data to be read from the boundary of the chunk (step S2310: No), the storage device 202 returns to the processing in step S2302.

Meanwhile, in step S2309, when the migrated capacity is equal to or greater than the capacity of the migration source logical volume 111 (step S2309: Yes), the storage device 202 sets information indicating termination of the migration in the field for the migration state in the migration management table 500, and terminates the processing for thin provisioning. In this way, the storage device 202 is capable of suppressing the increase in the physical area allocated to the migration destination logical volume 121.

### Example of Read Processing Procedure

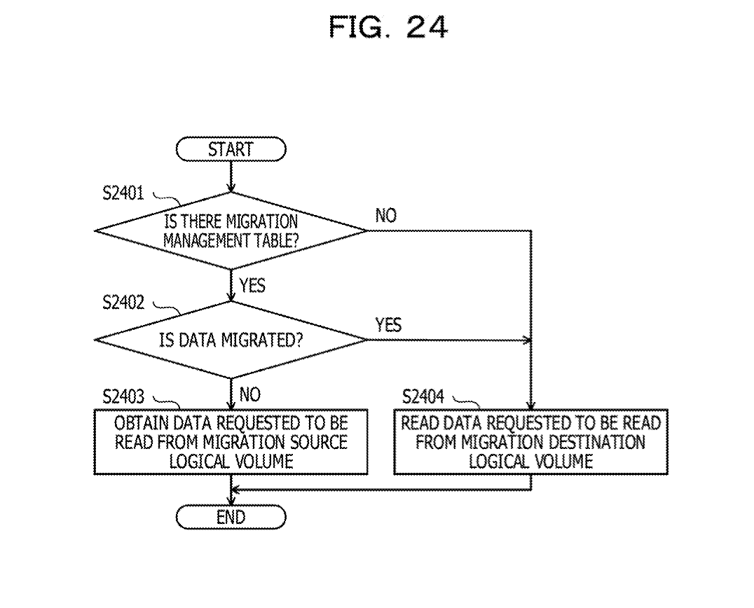

Next, an example of a read processing procedure is described with reference to FIG. 24. Here, a case where the migration destination storage device 202 executes the read processing is described. In the description below, the migration destination storage device 202 may be simply referred to as “storage device 202”.

FIG. 24 is a flowchart illustrating the example of the read processing procedure. In FIG. 24, after receiving the read request, the storage device 202 determines whether or not there is the migration management table 500 (step S2401). Here, when there is the migration management table 500 (step S2401: Yes), the storage device 202 determines whether or not the data requested to be read is the migrated data (step S2402).

Here, when the data is not the migrated data (step S2402: No), the storage device 202 transmits the read request to the migration source storage device 201 and obtains the data requested to be read from the migration source logical volume 111 (step S2403). Then, the storage device 202 terminates the read processing.

On the other hand, when there is no migration management table 500 (step S2401: No), the storage device 202 reads the data requested to be read from the migration destination logical volume 121 included in its own device (step S2404). Likewise, when the data is the migrated data (step S2402: Yes), the storage device 202 reads the data requested to be read from the migration destination logical volume 121 included in its own device (step S2404).

Then, the storage device 202 terminates the read processing. In this way, the storage device 202 is capable of returning the data requested to be read to the computer that transmits the read request. In addition, when the data requested to be read is in the migration destination logical volume 121, the storage device 202 is capable of reading the data from the migration destination logical volume 121 and responding to the transmission source computer. This achieves the decrease in the time to respond.

### Example of Write Processing Procedure

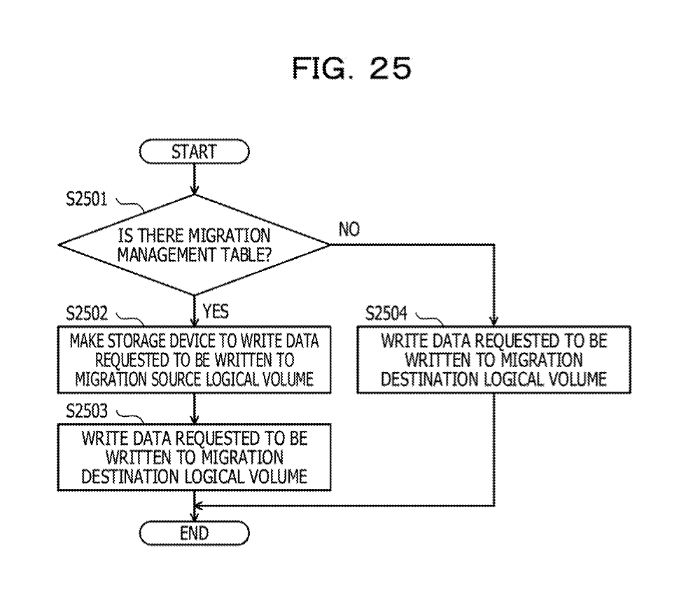

Next, an example of a write processing procedure is described with reference to FIG. 25. Here, a case where the migration destination storage device 202 executes the write processing is described. In the description below, the migration destination storage device 202 may be simply referred to as “storage device 202”.

FIG. 25 is a flowchart illustrating the example of the write processing procedure. In FIG. 25, after receiving the write request, the storage device 202 determines whether or not there is the migration management table 500 (step S2501). Here, when there is the migration management table 500 (step S2501: Yes), the storage device 202 transmits the write request to the migration source storage device 201 and makes the migration source storage device 201 to write the data requested to be written to the migration source logical volume 111 (step S2502). Next, the storage device 202 writes the data requested to be written to the migration destination logical volume 121 included in its own device (step S2503). Then, the storage device 202 terminates the write processing.

On the other hand, when there is no migration management table 500 (step S2501: No), the storage device 202 writes the data requested to be written to the migration destination logical volume 121 included in its own device (step S2504). Then, the storage device 202 terminates the write processing. In this way, the storage device 202 is capable of writing the data requested to be written in such a way as to maintain consistency between the migration source logical volume 111 and the migration destination logical volume 121.

As described above, the storage control device 100 is capable of storing the first information d1, which indicates the position of the migrated data in the migration source logical volume 111, and the second information d2, which indicates the capacity of the migration source logical volume 111. In addition, the storage control device 100 is capable of sequentially reading the data from the beginning or the ending of the migration source logical volume 111 and migrating the data to the migration destination logical volume 121. Moreover, the storage control device 100 is capable of updating the first information d1 at every moment the data is migrated to the migration destination logical volume 121. Further, the storage control device 100 is capable of terminating the reading of the data when the capacity migrated from the migration source logical volume 111 is determined to be equal to or greater than the capacity of the migration source logical volume 111 based on the first information d1 and the second information d2.

This makes the storage control device 100 to be capable of suppressing the increase in the size of the management data, which manages the progress of the data migration, even when the capacity of the migration source logical volume 111 increases. In addition, since the bitmap is not used, when receiving the read request and the write request from the host device, the storage control device 100 is capable of executing the read processing and the write processing for each set of the data having comparatively small capacity, thereby suppressing the increase in the time to respond to the host device.

Moreover, when the migration destination logical volume 121 is the logical volume for thin provisioning, the storage control device 100 is capable of determining whether or not the storage area in the migration source logical volume 111 associated with the management unit of thin provisioning is a free space. Further, when the logical volume is determined to be not a free space, the storage control device 100 is capable of allocating a physical area to the storage area in the migration destination logical volume 121 associated with the storage area in the migration source logical volume 111. Furthermore, the storage control device 100 is capable of migrating the data read from the storage area in the migration source logical volume 111 to the storage area to which the physical area is allocated. In this way, the storage control device 100 is capable of allocating a physical area and migrating the data to the migration destination logical volume 121.

In addition, when the logical volume is determined to be a free space, the storage control device 100 is capable of updating the first information d1 without allocating a physical area to the storage area in the migration destination logical volume 121 associated with the storage area in the migration source logical volume 111. In this way, when the data to be migrated to any chunk in the migration destination logical volume 121 is zero data, the storage control device 100 is capable of migrating zero data in appearance by allocating no physical area to such a chunk. As a result, the storage control device 100 is capable of suppressing the increase in the physical area allocated to the migration destination logical volume 121.

Moreover, when receiving the request for reading the data from the migration source logical volume 111, the storage control device 100 is capable of determining whether or not the data requested to be read has been migrated to the migration destination logical volume 121. Further, when it is determined that the data has not been migrated yet, the storage control device 100 is capable of reading the data requested to be read from the migration source logical volume 111. In this way, the storage control device 100 is capable of returning the data requested to be read to the computer that transmits the read request.

Furthermore, when it is determined that the data has been migrated, the storage control device 100 is capable of reading the data requested to be read from the migration destination logical volume 121. In this way, when the data requested to be read is in the migration destination logical volume 121, the storage control device 100 is capable of reading the data from the migration destination logical volume 121 and responding to the transmission source computer. This achieves the decrease in the time to respond.

In addition, when receiving the request for writing the data to the migration source logical volume 111, the storage control device 100 is capable of writing the data requested to be written to the migration source logical volume 111 and the migration destination logical volume 121. This makes the storage control device 100 to be capable of writing the data requested to be written in such a way as to maintain consistency between the migration source logical volume 111 and the migration destination logical volume 121.

Moreover, when the capacity migrated from the migration source logical volume 111 is determined to be equal to or greater than the capacity of the migration source logical volume 111, the storage control device 100 is capable of deleting the first information d1 and the second information d2. This makes the storage control device 100 to be capable of making the storage area to be efficiently utilized.

Note that the storage control method described in the embodiment may be implemented by executing a prepared program by a computer such as a personal computer or a workstation. The storage control program is stored in a computer-readable storage medium such as a hard disk, a flexible disk, a CD-ROM, an MO, or a DVD, and is executed by being read from such a storage medium using a computer. Otherwise, the storage control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device configured to control data migration from a first storage area of a first capacity to a second storage area, the storage control device comprising:
a memory; and
a processor coupled to the memory and configured to:
migrate, from the first storage area to the second storage area, a plurality of data of a certain size in order based on addresses of the plurality of data in the first storage area,
update first information indicating the address of data in the first storage area, the data being included in the plurality of data and being migrated to the second storage area, when the respective data is migrated to the second storage area in order,
store, in the memory, the updated first information,
specify a second capacity, which is a total capacity of the data migrated to the second storage area, based on the updated first information stored in the memory,
determine whether the specified second capacity reaches the first capacity, and
stop migrating the data when it is determined that the second capacity reaches the first capacity.

2. The storage control device according to claim 1, wherein:
the first information includes the number of times of migrating the data to the second storage area.

3. The storage control device according to claim 2, wherein the processor is configured to:
specify the second capacity by multiplying the number of times of the migration by the certain size.

4. The storage control device according to claim 3, wherein the processor is configured to:
store, in the memory, second information indicating the first capacity.

5. The storage control device according to claim 1, wherein the processor is configured to:
determine, when the second storage area is a logical volume for thin provisioning, whether a first area associated with a management unit of the thin provisioning is a free space,
allocate a physical area to a second area associated with the first area and migrate the data from the first area to the second area when it is determined that the first area is not a free space, and
update the first information without allocating the physical area to the second area when it is determined that the first area is a free space.

6. The storage control device according to claim 5, wherein the management unit is a chunk in the logical volume for the thin provisioning.

7. The storage control device according to claim 1, wherein the processor is configured to:
receive a data read request,
determine, based on the first information, whether reading target data, which is a target of the data read request, has been migrated to the second storage area,
read the reading target data from the first storage area when it is determined that the reading target data has not been migrated to the second storage area, and
read the reading target data from the second storage area when it is determined that the reading target data has been migrated to the second storage area.

8. The storage control device according to claim 1, wherein the processor is configured to:
write writing target data, which is a target of a data write request, to the first storage area and the second storage area when receiving the data write request to write the data to the first storage area.

9. The storage control device according to claim 4, wherein the processor is configured to:
delete the first information and the second information from the memory when it is determined that the second capacity reaches the first capacity.

10. The storage control device according to claim 1, wherein a minimum data reading unit of the first storage area is a sector, and the certain size is a size including a plurality of the sectors.

11. A method of controlling data migration from a first storage area of a first capacity to a second storage area, the method comprising:
migrating, from the first storage area to the second storage area, a plurality of data of a certain size in order based on addresses of the plurality of data in the first storage area;
updating first information indicating the address of data in the first storage area, the data being included in the plurality of data and being migrated to the second storage area, when the respective data is migrated to the second storage area in order;
storing, in the memory, the updated first information;
specifying a second capacity, which is a total capacity of the data migrated to the second storage area, based on the updated first information stored in the memory;
determining whether the specified second capacity reaches the first capacity; and
stopping migrating the data when it is determined that the second capacity reaches the first capacity.

12. The method according to claim 11, wherein:
the first information includes the number of times of migrating the data to the second storage area.

13. The method according to claim 12, further comprising:
specifying the second capacity by multiplying the number of times of the migration by the certain size.

14. The method according to claim 13, further comprising:
storing, in the memory, second information indicating the first capacity.

15. The method according to claim 11, further comprising:
determining, when the second storage area is a logical volume for thin provisioning, whether a first area associated with a management unit of the thin provisioning is a free space;
allocating a physical area to a second area associated with the first area and migrate the data from the first area to the second area when it is determined that the first area is not a free space; and
updating the first information without allocating the physical area to the second area when it is determined that the first area is a free space.

16. A non-transitory computer-readable storage medium storing a program that causes an information processing apparatus to execute a process, the process comprising:
migrating, from a first storage area to a second storage area, a plurality of data of a certain size in order based on addresses of the plurality of data in the first storage area;
updating first information indicating the address of data in the first storage area, the data being included in the plurality of data and being migrated to the second storage area, when the respective data is migrated to the second storage area in order;
storing, in the memory, the updated first information;
specifying a second capacity, which is a total capacity of the data migrated to the second storage area, based on the updated first information stored in the memory;
determining whether the specified second capacity reaches the first capacity; and
stopping migrating the data when it is determined that the second capacity reaches the first capacity.

17. The non-transitory computer-readable storage medium according to claim 16, wherein:
the first information includes the number of times of migrating the data to the second storage area.

18. The non-transitory computer-readable storage medium according to claim 17, wherein the process further comprises:
specifying the second capacity by multiplying the number of times of the migration by the certain size.

19. The non-transitory computer-readable storage medium according to claim 18, wherein the process further comprises:
storing, in the memory, second information indicating the first capacity.

20. The non-transitory computer-readable storage medium according to claim 16, wherein the process further comprises:
determining, when the second storage area is a logical volume for thin provisioning, whether a first area associated with a management unit of the thin provisioning is a free space;
allocating a physical area to a second area associated with the first area and migrate the data from the first area to the second area when it is determined that the first area is not a free space; and
updating the first information without allocating the physical area to the second area when it is determined that the first area is a free space.
